(19) United States
(12) Patent Application Publication
(10) Pub. No.: US 2007/0253886 A1
(43) Pub. Date: Nov. 1, 2007

(54) Carbon sequestration and dry reforming process and catalysts to produce same

(75) Inventors: Nicolas Abatzoglou, Rock Forest (CA); Francois Gitzhofer, Rock Forest (CA); Denis Gravelle, Sherbrooke (CA); Jasmin Blanchard, Sherbrooke (CA); Karine De Oliveira-Vigier, Poitiers (FR); Hicham Oudghiri-Hassani, Ascot (CA); Henri Gauvin, Sherbrooke (CA)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(73) Assignees: Universite de Sherbrooke, Sherbrooke (CA); Socpra Sciences et Genie s.e.c., Sherbrooke (CA)

(21) Appl. No.: 11/725,134

(22) Filed: Mar. 15, 2007

Related U.S. Application Data
(63) Continuation-in-part of application No. 11/099,529, filed on Apr. 6, 2005.
(60) Provisional application No. 60/559,440, filed on Apr. 6, 2004.

(51) Int. Cl. C01B 31/02

(52) U.S. Cl. 423/445 R

(57) ABSTRACT

A carbon sequestration and dry reforming process for the production of synthesis gas and sequestered carbon from carbon dioxide. Two-dimension (non-porous) catalysts for sequestering carbon are also disclosed and a process to produce same as well as a method for activating two dimension catalysts.

### CROSS-REFERENCE TO RELATED APPLICATIONS

This application is a continuation-in-part of application Ser. No. 11/099,529 filed on Apr. 6, 2005 that claims priority of U.S. provisional patent application No. 60/559,440 filed on Apr. 6, 2004, both the specification of which are hereby incorporated by reference.

### BACKGROUND OF THE INVENTION

1) Field of the Invention

The present invention relates to a process to sequester carbon from organic material and, more particularly, to a dry reforming process maximizing the carbon recovery. It also relates to new catalysts for carbon sequestration and dry reforming processes.

2) Description of the Prior Art

Synthesis gas is a mixture composed primarily of hydrogen and carbon monoxide. Synthesis gas is used either in pure hydrogen production, as a raw material in the chemical industry for the manufacture of market valuable products or as an energy vector. It can also be converted to a solid or liquid synthetic fuel or “synfuel”.

Steam reforming reactions are widely used for the production of hydrogen streams and synthesis gas for a number of processes such as ammonia, methanol and Fischer-Tropsh process for the synthesis of carbon-containing compounds such as higher hydrocarbons.

Dry reforming with CO₂ is also a known process to produce or refine synthesis gas but there are so far no industrial applications due to the high endothermicity of reactions. For example, the reduction of carbon dioxide with methane is an endothermic reaction (ΔH₂₉₈=+247 kJ·mol⁻¹). At high temperatures, its favorable entropy change (ΔS₂₉₈=+257 J·K⁻¹·mol⁻¹) makes it a favorable equilibrium, ΔG₁₀₅₀=−23 kJ·mol⁻¹.
CH_{4(g)}+CO_{2(g)}→2CO_{(g)}+2H_{2(g)} (1)

During dry reforming, the CO is also partially converted into solid carbon through the reaction known as Boudouard reaction for CO disproportionation:
2CO_{(g)}→CO_{2(g)}+C₍ₛ₎ (2)

Multivalent iron oxides, such as magnetite, are known as catalysts for the Boudouard reaction (Renshaw et al. 1970, J. Catalysis 18, 164-183). There are several studies on the thermal treatment of carbon steels under various reactive atmospheres (O₂, CO₂ or H₂O, plus an inert constituent) (Abuluwefa et al. 1997, Metallurgical and Materials Transaction A, 28A, 1633-1641; Chen et al. 2002, Oxidation of Metals 57 (1-2), 53-79). Thus, a thermal treatment of steel, under a mixture of nitrogen and oxygen, results in the formation of a film of iron oxides at the surfaces of the steel. The temperature, oxygen concentration and post reaction cooling rate, are the principal parameters that influence the rate of film formation and the type(s) of the oxides formed (principally; wüstite (FeO), magnetite (Fe₃O₄, a spinel) and hematite (Fe₂O₃)) (Abuluwefa et al. 1997, Metallurgical and Materials Transaction A, 28A 1643-1651; Chen et al. 2003, Oxidation of Metals, 59 (5-6), 433-468; Abuluwefa et al. 1997, Metallurgical and Materials Transaction A, 28A, 1633-1641).

Several technical problems occur during dry reforming due to the carbon formation. Therefore, most prior art documents focus on processes, reactions and catalytic systems aiming at the reduction of the carbon deposition during dry reforming.

If the carbon formation is undesired from a process point of view, it is however advantageous from an environmental point of view since carbon dioxide is a greenhouse effect gas (GHG). The amount of carbon formed during dry reforming diminishes the release of carbon dioxide in the atmosphere, thereby reducing GHG emissions.

### SUMMARY OF THE INVENTION

Accordingly, an object of the present invention is to provide a process for sequestering carbon from carbon dioxide for reducing greenhouse effect gas emissions.

Yet another object of the present invention is to provide a class of catalysts that is capable of reforming organic gases to carbon monoxide and hydrogen while generating carbon deposits.

Still another object of the present invention is to provide a process for dry reforming renewable resources while simultaneously sequestering carbon.

According to one object of the present invention, there is provided a carbon sequestration and dry reforming process. The process comprises the steps of: providing a reactant gas mixture including carbon dioxide and an organic material; providing at least one catalyst for dry reforming the reactant gas mixture and sequestering carbon, at least one of the at least one catalyst being a two-dimension carbon sequestration catalyst; contacting the reactant gas mixture with the at least one catalyst under conditions wherein the reactant gas mixture is at least partly reformed into a product gas mixture including a synthesis gas and solid carbon particles formed on the surface of the at least one two-dimension carbon sequestration catalyst; and recovering the product gas mixture and the solid carbon particles.

The carbon sequestration and dry reforming process can optionally further comprise at least one additional step selected amongst the group of steps comprising: mechanically withdrawing the solid carbon particles, adding steam to the reactant gas mixture, and activating the catalyst by preheating the catalyst under an inert gas flow followed by an oxidizing step or carry out both steps simultaneously.

In the carbon sequestration and dry reforming process, the dry reforming of the reactant gas mixture can be first carried on a three dimension catalyst at a first reaction temperature and the sequestering of the carbon can be then carried on the at least one two dimension catalyst at a second reaction temperature. The at least one catalyst can comprise an active metal deposited on one of a non-porous support and/or an iron-based catalytic material located at the surface of, or superficially on, at least one monolith support.

The product gas mixture obtained from the carbon sequestration and dry reforming process can be used in a fuel cell and the reactant gas mixture can be an output product of a fuel cell.

According to another object of the present invention, there is provided a filamentous carbon material resulting from the carbon sequestration and dry reforming process described above.

According to another object of the present invention, there is provided a synthesis gas resulting from the carbon sequestration and dry reforming process described above.

According to another object of the present invention, there is provided a carbon sequestration method in a dry reforming process. The method comprises bringing at least one of a reactant gas mixture including carbon dioxide and an organic material and a dry reformed gas in contact with a two-dimension carbon sequestration catalyst at a temperature wherein a solid carbon deposit is formed at the surface of the two-dimension carbon sequestration catalyst.

In the carbon sequestration method, the two-dimension carbon sequestration catalyst can comprise an activated iron-based catalytic material which can include at least one of nickel, chrome and cobalt alloying elements or can be a high temperature resistant iron alloy. In one particular embodiment, the iron-based catalytic material comprises iron carbides FeₓC (wherein x is an integer of Fe that forms a stable combination with C as will be recognized by persons of skill in the art); (such as Fe₃C or Fe₇C) as well as iron oxides Fe_{Y}O_{Z} (wherein _{Y} and _{z} are integer that form a stable combination as will be recognized by persons of skill in the art; such as Fe₃O₄, Fe₂O₃ and FeO) and intermediate forms thereof, such as Fe_{0.95}O and Fe_{2.2}C. It is claimed that all chemical species that form various combination of iron (Fe), oxygen (O) and carbon (C) which can be formed during the pre-reported treatments have similar catalytic properties.

In the carbon sequestration method, the two-dimension carbon sequestration catalyst can comprise an active metal deposited on a non-porous support, the active metal being selected from the group consisting of nickel, platinum group metals promoted nickel, alkali-enhanced nickel, copper-promoted nickel, and tin-promoted nickel. The non-porous support can be a ceramic support selected from the group consisting of alumina, zirconia, and phosphate oxide or a metallic support comprising fritted molybdenum.

According to another object of the present invention, there is provided a carbon sequestration and dry reforming reactor. The reactor comprises at least one housing, each having at least one gas input and at least one gas output, the at least one gas input being adapted to receive a reactant gas mixture composed of an organic material and carbon dioxide; at least one catalyst disposed in at least one of the at least one housing for dry reforming the reactant gas mixture circulating therein into a product gas mixture and sequestering carbon, at least one of the at least one catalyst being a two-dimension carbon sequestration catalyst; and a heater operatively connected to the reactor for heating at least one of the gas mixture and the at least one catalyst.

The reactor can comprise at least two housings, a first of the at least two housings comprising a three dimension dry reforming catalyst for dry reforming the reactant gas mixture and a second of the at least two housings comprising the at least one two dimension carbon sequestration catalyst.

In the reactor, one of the at least one housing can comprise a three dimension dry reforming catalyst for dry reforming the reactant gas mixture and the at least one two dimension carbon sequestration catalyst.

The reactor can be operable in at least one of solid carbon recovery mode and catalyst regeneration mode.

According to a further object of the present invention, there is provided a reforming catalyst. The catalyst comprises an active metal deposited on one of a non-porous support selected from the group consisting of a non-porous metallic support and a non-porous ceramic support, the active metal being selected from the group consisting of nickel, platinum group metals promoted nickel, alkali-enhanced nickel, copper-promoted nickel, and tin-promoted nickel.

The non-porous support can be a ceramic support selected from the group consisting of alumina, zirconia, and phosphate oxide or a metallic support comprising fritted molybdenum.

The reforming catalyst can be a dry reforming catalyst and/or a two dimension catalyst.

The catalyst can be obtained by impregnation of the non-porous support using one of nitrate salts and chloride salts of the active metal or by thermal plasma deposition on the non-porous support using one of nitrates, carbonates, and chlorides of the active metal.

According to another object of the present invention, there is provided a two-dimension reforming catalyst manufacturing process. The process comprises: providing a non-porous support; providing a catalytic metal precursor selected from the group consisting of nickel, platinum group metals promoted nickel, alkali-enhanced nickel, copper-promoted nickel, and tin-promoted nickel; and deposing the catalytic metal precursor over the non-porous support.

In the two-dimension reforming catalyst manufacturing process, the non-porous support can be selected from the group consisting of a non-porous metallic support and a non-porous ceramic support.

The process can further comprise depositing the catalytic metal precursor by thermal plasma deposition using one of nitrates, carbonates, and chlorides of the catalytic metal precursor or depositing the catalytic metal precursor by impregnation of the non-porous support using one of nitrate salts and chloride salts of the metal.

According to another object of the present invention, there is provided a two-dimension catalyst manufacturing process, comprising: providing a non-porous support; providing a catalytic metal precursor selected from the group consisting of nickel, platinum group metals promoted nickel, alkali-enhanced nickel, copper-promoted nickel, and tin-promoted nickel; and deposing a catalytic material over the support by thermal plasma deposition of the catalytic metal precursor.

In the two-dimension catalyst manufacturing process, the catalytic metal precursor can be one of a nitrate, a carbonate, and a chloride. The non-porous support can be selected from the group consisting of a non-porous metallic support and a non-porous ceramic support.

The two-dimension catalyst manufacturing process can further include pressing the deposited catalytic material over the substrate and/or heating the deposited catalytic material under an inert gas flow.

According to another object of the present invention, there is provided a two-dimension carbon sequestration catalyst. The catalyst comprises: an iron-based non-porous catalytic material activated by heating to a temperature ranging between 700 and 900° C. under oxidative atmosphere or under inert gas followed by an oxidative treatment.

According to another object of the present invention, there is provided a two-dimension carbon sequestration catalyst that comprises: an iron-based non-porous catalytic material activated by thermal-oxidative treatment on a low carbon steel sheet.

### BRIEF DESCRIPTION OF THE DRAWINGS

Further features and advantages of the present invention will become apparent from the following detailed description, taken in combination with the appended drawings, in which:

FIG. 1 is a schematic view of a reactor used in a carbon sequestration and dry reforming process in accordance with an embodiment of the invention, wherein the reactor includes one catalytic bed;

FIG. 2 is a schematic flow sheet of the carbon sequestration and dry reforming process in accordance with an embodiment of the invention, wherein the reactor includes one catalytic bed;

FIG. 3 is a micrograph of a carbon deposit obtained by the carbon sequestration and dry reforming process;

FIG. 4 is a schematic view of an induction plasma torch used to produce a catalyst in accordance with an embodiment of the invention;

FIG. 5 is a schematic flow sheet of a process for the gasification of waste containing organic material followed by the carbon sequestration and dry reforming process of the gaseous organic material in accordance with an embodiment of the invention;

FIG. 6 is a schematic flow sheet of the carbon sequestration and dry reforming process in accordance with an embodiment of the invention, wherein the reactor includes two catalytic beds;

FIG. 7 is a schematic view of a reactor used in the carbon sequestration and dry reforming process in accordance with an embodiment of the invention, wherein the reactor includes two catalytic beds;

FIG. 8 includes FIGS. 8a, 8b, 8c, and 8d and are micrographs of carbon whiskers formed in the presence of two catalysts (Ni/Al₂O₃—ZrO₂ and thermally activated carbon steel) taken respectively at 500 nm, 1000 nm, 100 nm, and 1 μm;

FIG. 9 is an elementary analysis of a sequestered carbon particle on a two dimension activated carbon steel catalyst during the carbon sequestration and dry reforming process;

FIG. 10 is a graph representing the evolution of the product gas mixture as a function of the time with the reactant gas mixture having ratios of 0.82 mol of methane per mol of CO₂ and 0.08 mol of H₂O per mol of CO₂;

FIG. 11 is a graph representing the evolution of the product gas mixture as a function of the time with the reactant gas mixture having ratios of one mol of methane per mol of CO₂ and 0.08 mol of H₂O per mol of CO₂;

FIG. 12 is a schematic flow sheet of the carbon sequestration and dry reforming process in accordance with an embodiment of the invention, wherein two rows of reactors are operated in parallel;

FIG. 13 is a schematic flow sheet of the carbon sequestration and dry reforming process in combination with a solid oxide fuel cell in accordance with an embodiment of the invention;

FIG. 14 is the experimental set up as presented in Example 8;

FIG. 15 is A) an XRD spectrum and B) FEG image of the carbon steel 1008 before thermal treatment as presented in Example 8;

FIG. 16 is A) a graph representing no reaction observed with a flow of 25 ml/min and B) a graph representing a reaction in progress with a flow of 3 ml/min as presented in Example 8;

FIG. 17 is A) FEG image of the Catalyst 1 surface after its use under dry reforming conditions and b) FEG image of the Catalyst 2 surface after its use in dry reforming conditions as presented in Example 8;

FIG. 18 is A) an XRD spectrum and B) an FEG picture showing magnetite formed on carbon steel 1008 after thermal treatment at 800° C. for 1 h as presented in Example 8;

FIG. 19 is A) an FEG picture of Catalyst 3 surface after dry reforming and B) an FEG picture of Catalyst 4 surface after dry reforming as presented in Example 8; and

FIG. 20 is A) an FEG picture of Catalyst 5 (iron powder) surface after dry reforming and B) an FEG picture of Catalyst 6 (magnetite powder) surface after dry reforming as presented in Example 8.

It will be noted that throughout the appended drawings, like features are identified by like reference numerals.

### DETAILED DESCRIPTION OF THE PREFERRED EMBODIMENT

The present invention concerns a process that uses dry reforming reactions to sequester an important proportion of the carbon contained in a carbon dioxide molecule (CO₂), a greenhouse gas (GHG), while producing simultaneously synthesis gas from renewable resources, like biogas and bio-ethanol. The sequestered carbon forms an inert solid powder that is removed from the process, and simultaneously reducing greenhouse effect gas emissions.

The process aims to the maximization of the carbon deposition during the dry reforming process. Therefore, catalysts maximizing the carbon deposition are necessary. The catalysts used for carbon sequestration are two-dimension (2D) catalyst formulations, i.e. in the case of support catalyst formulations, the active element is located only at the surface of, or superficially on, the support, for maximizing carbon deposition and allowing mechanical recovering of the solid carbon deposited at the surface of the 2D catalyst.

In the carbon sequestration and dry reforming process, a reactant gas mixture, including an organic material in gaseous state and carbon dioxide, enters in contact with one or several catalysts (at least one of the catalysts is a 2D catalyst for carbon sequestration) in predetermined conditions for dry reforming the reactant gas mixture into a product gas mixture and the formation of a solid carbon deposit at the surface of a 2D catalyst. The product gas mixture includes a synthesis gas. The solid carbon deposit and the product gas mixture are recovered for ulterior uses. As will be described in more details below, the carbon sequestration and dry reforming process can be carried out in one or more reactors.

The process can include one or two catalysts for carrying out the dry reforming and the carbon sequestration, at least one being a 2D catalyst for maximizing the carbon sequestration and allowing mechanical retrieval of the sequestered carbon. In one embodiment, only one 2D catalyst is used for both dry reforming and carbon sequestration. In another embodiment, a first three-dimension (3D) catalyst is used for dry reforming and a second 2D catalyst is used for carbon sequestration. To maximize the carbon sequestration on the second catalyst, it is desirable to minimize the carbon deposition on the first 3D catalyst, as will be described in more details below. The two catalysts can be disposed in the same reactor or in different reactors.

The 2D catalyst for both dry reforming and carbon sequestration can be based on active metals deposited on a non-porous metallic or ceramic support, such as:
a) nickel acting as the main reforming catalytic agent on a non-porous alumina, zirconia or phosphate based support;
b) platinum group metals (i.e. Rh, Ru)-promoted nickel on a non-porous alumina, zirconia or phosphate based support;
c) alkali-enhanced nickel on a non-porous alumina, zirconia or phosphate based support;
d) copper-promoted nickel on a non-porous alumina, zirconia or phosphate based support; and
e) tin-promoted nickel on a non-porous alumina, zirconia or phosphate based support.

The active metal can also be deposited on a metallic support such as fritted Mo.

The 2D catalysts are obtained either by impregnation of the non-porous matrices using nitrate or chloride salts of the catalytic metals or by thermal plasma deposition on the non-porous metallic or ceramic support using nitrates, carbonates, chlorides, and the like, as will be described in more details below.

3D catalysts having a similar composition can also be produced for dry reforming and carbon sequestration processes using two catalysts. The dry reforming of the reactant gas mixture occurs with the 3D catalyst while the carbon sequestration occurs on a following 2D catalyst.

The 2D catalysts for carbon sequestration can also be based on iron alloys with a wide concentration range of diverse alloying elements, such as nickel, chrome and cobalt, among others. It can also be high temperature resistant type iron alloys. The iron-based catalysts, such as steel-based, are activated by preheating, as will be described in more details below. The catalysts are under the form of a non-porous monolith allowing the carbon formed to remain at the surface of the catalyst and to be removable from the catalyst by mechanical means, such as air or liquid jets.

For example, the 2D carbon sequestration catalysts can be alloys of Fe/Ni/Cr/Co with a wide range of concentrations of the diverse elements from 100% Fe to high temperature resistant type alloys. The 2D catalysts are activated by preheating in a range from 700 to 900° C. under an oxidative gas flow or under an inert gas and exposed to oxidative gas at any temperature before reaction. Alternatively, intermediate-types of catalytic material can be low carbon steel sheet submitted to thermal-oxidative treatment. The thermal oxidative treatment consists of heating the carbon steel at high temperature (above 400° C.) and oxidizing its surface at room temperature.

The present invention discloses that a simple iron-based, non-porous catalytic formulation, allows the production of carbon MWNT (multiwalls nanotubes) and nanofilaments during dry reforming, without harm to the catalytic properties. The reaction takes place at the expense of the iron catalyst, which is consumed as nanograins inside the MWNT, but this does not cause significant concern because of the low cost of the original catalyst material. It is also shown that the reforming catalytic properties of these iron-based formulations are not available before their thermal pretreatment.

In the case of iron-based 2D catalysts, it has been demonstrated that the iron must first be oxidized in order to produce particles of magnetite (and other types of oxidized iron, Fe_{y}O_{z}) that are, then, transformed into iron carbides (FeₓC). Iron carbides constitute the final activated form of the catalyst useful for the carbon sequestration per se that will give rise to the carbon filaments. High temperature and oxidation are required to produce such filaments and will have an influence on the size and morphology of formed particles and hence on the formation of carbon filaments.

Iron oxides are intermediate compounds easily accessible to use instead of iron as starting material. Other 2D catalysts useful in the present invention are therefore ferrous oxides Fe_{y}O_{z} such as, for example, magnetite (Fe₃O₄), hematite (Fe₂O₃) and wüstite (FeO), or any other intermediate form or forms having a stoichiometric deficit (Fe_{0.95}O, Fe_{2.2}C, etc.).

The magnetite particles are able to reform the ethanol and CO₂ into H₂, CO and nanofilaments via the formation of iron carbide particles (Fe₃C). These iron carbide particles are obtained from the magnetite particles via reduction and carbon sequestration reactions and are the active catalysts for the production of carbon nanofilaments.

The purpose of the 2D catalysts is to maximize the sequestration of the carbon associated with the carbon dioxide and to allow a removal of the sequestered carbon by mechanical means. The sequestered carbon is removed, thus contributing to the decrease of GHG emissions.

The sequestered carbon forms an inert solid powder superficially deposited on the catalyst. However, to preserve a catalyst activity as high as possible for as long as possible, the carbon deposited is preferably unloaded, if possible continuously. Therefore, the reactor configuration for the dry reforming process preferably allows the unloading of the solid carbon deposited.

As one skilled in the art will appreciate, the reactor can be a fluidized bed or a fixed-bed reactor. The carbon deposited can be retrieved by mechanical effects such as interparticle friction in fluidized bed reactor or washing fluid spray such as air or liquid jets. Vibrations and gravity can also be applied on the reactor to retrieve the solid carbon deposited. Vibrations release the sequestered carbon from the catalyst matrix.

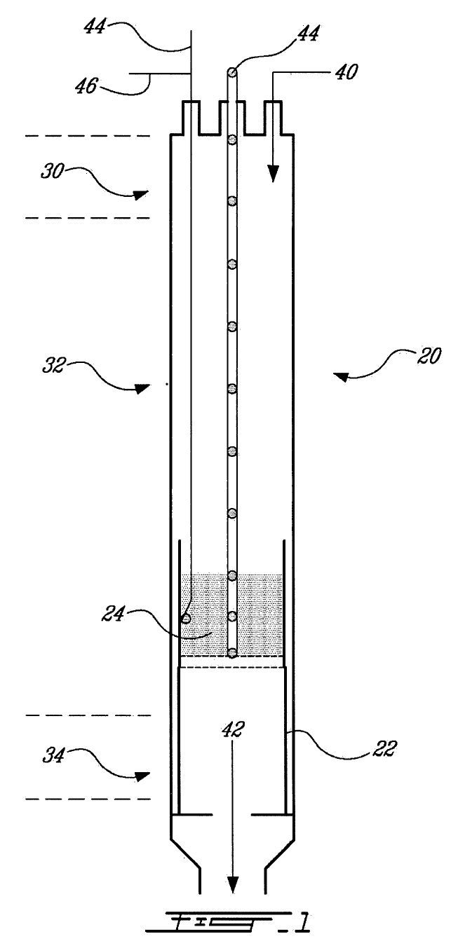

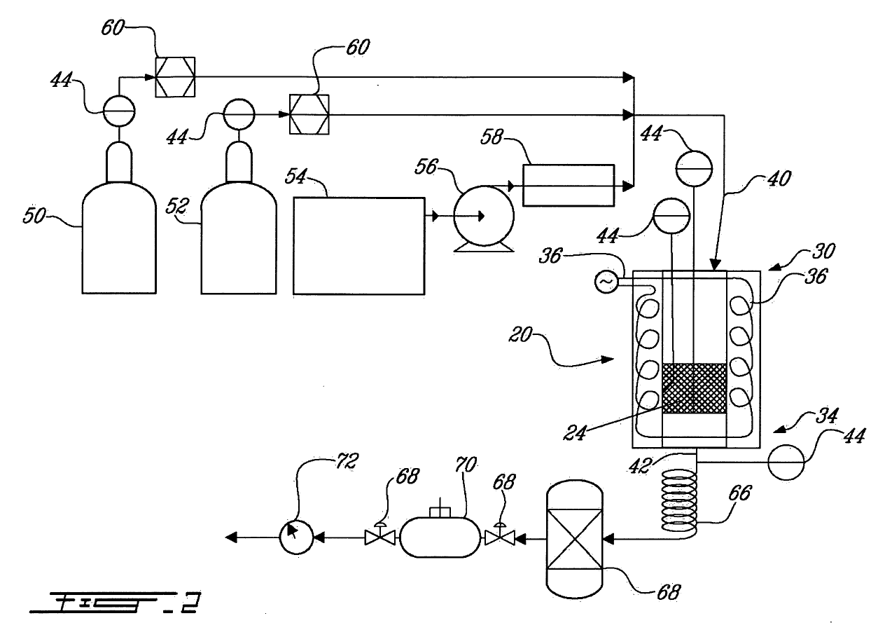

Referring now to FIG. 1, there is shown a fixed-bed reactor 20. The reactor 20 has a catalyst table 22 on which a 2D catalyst 24 is disposed. The reactor 20 is longitudinally divided into three portions: an upper portion 30, a middle portion 32, and a lower portion 34. The upper and lower portions 30, 34 are not heated while the middle portion 32 is provided with heating elements 36 (FIG. 2). A reactant gas mixture 40, being composed of an organic material in gaseous state and carbon dioxide, is introduced in the upper portion 30 of the reactor 20. The organic material preferably includes resources such as hydrocarbons, oxygenated organic molecules, bio-oils, and bio-fuels. Depending on the bio-combustible used, 0 to 10 wt % of water in the form of steam can be added to the reactant gas mixture 40.

Once introduced into the reactor 20, the reactant gas mixture 40 goes down and is heated while going down until the reaction temperature is reached. Thereafter, the reactant gas mixture 40 is in contact with the 2D catalyst 24 where it is reformed into a product gas mixture 42 leaving a carbon deposit (not shown) at the surface of the catalyst 24. The product gas mixture 42 exits at the lower portion 34 of the reactor 20. The composition of the product gas mixture 42 includes carbon monoxide, hydrogen, and water.

In the best conditions, one would expect that for each mole of CO₂ being processed, one mole of carbon would be recovered.

For carbon deposit unloading, the 2D catalyst 24 can be washed with a fluid spray (not shown). Frequent unloading, preferably continuous, of the carbon deposit preserves the catalyst activity as high as possible for as long as possible. The 2D catalyst formulations described above enhance the reforming rate while keeping the carbon formed at the surface of the catalyst. It is also possible to use two reactors which are alternatively operated in reforming and carbon recovering modes, as will be described in more details below.

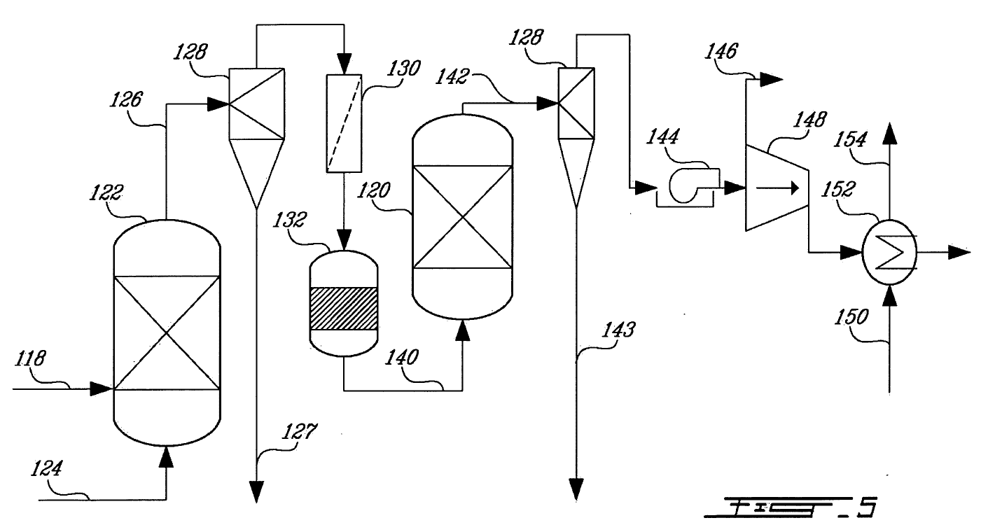

The dry reforming process can also be carried out in a fluidized bed reactor 120 (FIG. 5). The sequestered carbon is released from the catalyst particles due to the friction between the particles. The carbon released is recovered with the gas. The solid-gas separation can be carried out with a cyclone 128 (FIG. 5) and, if needed, a filter (not shown).

The reactor 20 can also include sensors such as thermocouples 44 and pressure gages 46 to monitor and/or control the process. Temperature sensors 44 insure the homogeneity of the temperature profile inside the catalytic bed. In FIG. 1, a first thermocouple 44 acquires data proximate to a reactor wall and a second thermocouple 44 reads the temperature at several locations along the reactor 20 in the center of the latter. The reaction is usually easier to carry out at low pressures. Therefore, the reactor 20 is typically operated at atmospheric pressure. It is not necessary to control the reactor pressure. One skilled in the art will appreciate that the reactor 20 can contain a plurality of sensors and not only the ones illustrated on FIG. 1.

The molar ratio of organic material and CO₂ in the reactant gas mixture 40 typically ranges between 0.3 and 3, preferably between 0.5 and 2. Several factors, such as chemical equilibrium, optimization of reforming, and optimization of carbon sequestration, guide the ratio choice. The optimization of reforming and carbon sequestration depends on the nature of the organic material.

The reaction temperature also depends on the nature of the organic material. The reforming reaction occurs at a reasonable reaction rate when the Gibbs free energy becomes negative. With positive values of the Gibbs free energy (ΔG), the reforming reaction still occurs but the reaction rate is imperceptible. For example, the minimum reaction temperature for methanol is proximate to 200° C. and for methane proximate to 627° C.

As an example, the reduction of carbon dioxide with methane (or dry reforming of methane) is an endothermic reaction (ΔH₈₀₀=+158 MJ·kmol⁻¹).
CH_{4(g)}+CO_{2(g)}→CO_{(g)}+H_{2(g)}+H₂O_{(g)}+C₍ₛ₎ (2)

At a temperature of 800° C., with the dry reforming process, a conversion higher than 98 and 97 mol % for CH₄ and CO₂ respectively was observed.

The reduction of carbon dioxide with ethanol (or dry reforming of ethanol) is also an endothermic reaction (ΔH₄₀₀=+166 MJ·kmol⁻¹).
C₂H₅OH_{(g)}+CO_{2(g)}→2CO_{(g)}+2H_{2(g)}+H₂O_{(g)}+C₍ₛ₎ (3)

With the present dry reforming process, at temperatures higher than 400° C., a substantially complete conversion of C₂H₅OH and CO₂ is observed.

### EXAMPLES

### Example 1

The first example refers to FIG. 2, which is a schematic flow sheet of the carbon sequestration and dry reforming process, at a laboratory scale, wherein either a gaseous or a liquid organic material is dry reformed. The process includes a source of carbon dioxide 50 in gaseous state, a source of an organic material in gaseous state 52, and/or a source of an organic material in liquid state 54. If dry reformed, the organic material in liquid state 54 at ambient temperature is pumped with a pump 56 to a preheater 58. The preheater 58 heats the organic material in liquid state 54 until it volatilizes. Mass flow meters 60 can be positioned on the gas lines to measure on line the reactant masses. The carbon dioxide 50 and at least one of the organic material in gaseous state 52 and the organic material in liquid state 54, now in gaseous state, form the reactant gas mixture 40. The reactant gas mixture 40 enters the upper portion 30 of the reactor 20 and is heated while moving downwardly to reach the reaction temperature. The reactant gas mixture 40 is passed through the 2D catalyst 24 where it is dry reformed into a product gas mixture 42 leaving a carbon deposit (not shown) superficially on the 2D catalyst 24. The product gas mixture 42 exits at the lower portion 34 of the reactor 20 and is cooled down in a cooler 66. The product gas mixture 42, which contains water as a product of the dry reforming reaction, is then dried in a dryer 68. Thereafter, a sample of the product gas mixture 42 can be taken in a sampler 70 to analyze the quality of the product gas mixture 42 obtained by the dry reforming process. The flow of the product gas mixture 42 produced can also be measured with a dry flow meter 72. The dry reforming process can also include several sensors such as thermocouples 44 or pressures gages 46 or analytical tools (not shown).

### Example 2

The following example relates to the dry reforming of ethanol in the presence of ruthenium-promoted nickel on an alumina based support catalyst (NiRu/Al₂O₃ catalyst). Equation (3) (referred to above) is the dry reforming reaction.

Preparation of the Catalyst

The catalyst was prepared by co-impregnation of the support, which in the example was alumina, with RuCl₃ and Ni(NO₃)₂.6H₂O precursors. An appropriate amount of the metal salts in an aqueous solution was added to the support (8 grams of Al₂O₃, 0.3238 gram of RuCl₃, 3.17 grams of Ni(NO₃)₂.6H₂O). After a stirring maintained during 24 hours, the solid was placed in an oven for 12 hours at 80° C. The catalyst was then calcinated with air at 400° C. for 5 hours with a temperature ramp of 3° C./minute.

Before initiating the experiment, the catalyst was reduced in situ under a hydrogen flow (150 ml/min) during 90 minutes at 400° C. The temperature was increased to the reaction temperature under nitrogen.

Catalytic Test and Results

The dry reforming of ethanol was performed at 500° C. during 90 minutes under a carbon dioxide (CO₂) flow of 200 ml per minute and a molar ratio of ethanol to carbon dioxide ([C₂H₅OH]/[CO₂]) equal to 0.5. One gram of catalyst was used. Referring to Table 1, it can be seen that the results obtained, after 90 minutes of reaction, in the presence of this catalyst show the formation of hydrogen, carbon monoxide, methane, and other products such as ethylene and ethane.

TABLE 1

| | | | | | Other |
|---|---|---|---|---|---|
| | H₂ | CO | CO₂ | CH₄ | products |
| Gas (mol %) | 47.2 | 14.5 | 24.6 | 8.9 | 4.8 |

Referring to Table 2, it can be seen that the yield of carbon and hydrogen formed after 90 minutes of reaction were high. The hydrogen yield was calculated as the ratio of the hydrogen formed during the reaction to the hydrogen introduced as ethanol. The carbon yield was determined by the ratio of the carbon formed to the carbon introduced with CO₂. Thus, a unit hydrogen yield means that all hydrogen contained in ethanol is recovered (100 mol % recovery) and a unit carbon yield means that all carbon contained in CO₂ is recovered (100 mol % sequestration)

TABLE 2

| | H₂ | C (solid) |
|---|---|---|
| Yield (mol %) | 75 | 52 |

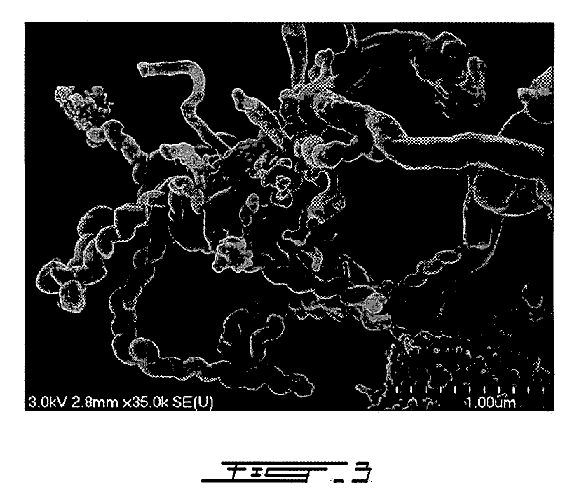

During this experiment, 5 grams of carbon were obtained with only 1 gram of catalyst. The sequestered carbon was analyzed by electron microscopy to identify its structure. Referring to FIG. 3, it will be seen that carbon whiskers were obtained. The sequestered carbon recovered is a valuable product.

Therefore, the NiRu catalyst supported over alumina leads to hydrogen with a 75 mol % yield and to a carbon sequestration via the formation of carbon whiskers which have an interesting added value.

### Example 3

The following example concerns the preparation of a 2D catalyst by the induction plasma technology.

The induction plasma technology has been used widely in the past to process materials. The ‘as-sprayed’ catalysts are produced using the suspension plasma spraying (SPS) concept (U.S. Pat. No. 5,609,921) applied to catalyst synthesis. Various approaches can be used in order to synthesize the catalyst. For instance Thermal Plasma Chemical Vapor Deposition (TPCVD) can be used by injecting nitrates for instance in the plasma discharge, as described in U.S. Pat. No. 5,032,568. However not every materials can be dissolved and the deposition rate in the vapor phase can be low. Working with saturated solutions such as suspensions can directly give a coating formed through the impingement of liquid droplets which are above the melting point of the catalysts and which can preserve some nanostructure because of the fast quench rate which can be imposed.

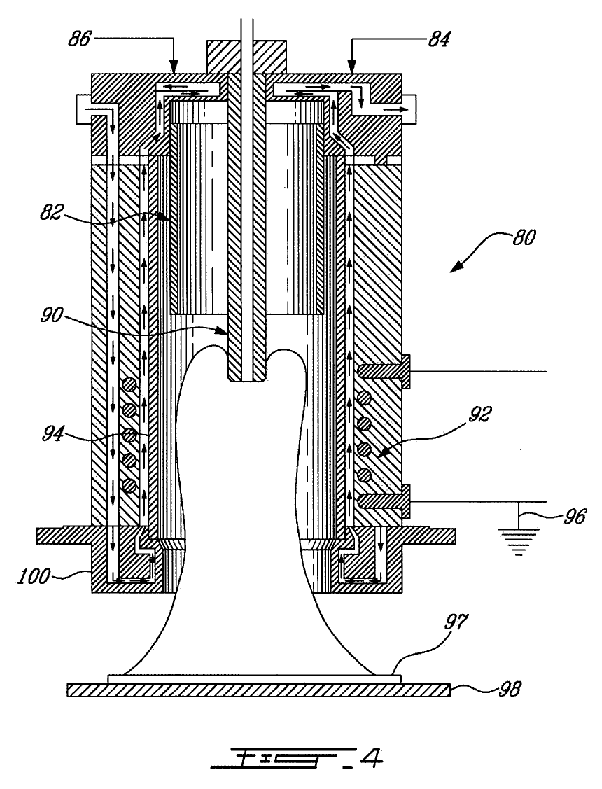

TPCVD was performed with an induction plasma torch (model PL50, TEKNA™ Plasma system Inc., Sherbrooke, Quebec, Canada) using a water-cooled ceramic plasma confinement tube, with a 50 mm inner diameter, in which a four-turn induction coil is incorporated. FIG. 4 shows a scheme of the setup given to the induction plasma torch 80. A quartz tube 82 is used to separate a sheath gas 84 from a central gas 86. The central gas 86 is introduced in the center of the torch 80 around a stainless steel injection probe 90, which is water cooled. The probe 90, the tip of which is located at the center of an induction coil 92, penetrates axially through the torch head to inject the solution. The precursors were injected into the Central Injection Probe (CIP) of the torch 80 with a peristaltic pump (not shown) to avoid reactions with the environment; the flow rate was kept constant. The sheath gas 84 is introduced in between the quartz tubes 82 and ceramic tubes 94. The coil 92 is connected to a radio frequency power supply 96 (3 MHZ, model TAFA® 32×50 MC build by Lepel). It also includes a supersonic output nozzle 100 having a convergent-divergent. The plasma torch 80 is used to form a deposit 97 over a substrate 98.

The substrate 98 was pressed during five (5) minutes and the obtained pellets were placed under an argon flow at 900° C. during 12 hours.

The deposited metals precursors were nitrate salts of the metals to be deposited and the solution was prepared by diluting these salts in distilled water at different metal concentrations.

### Example 4

The following example relates to mass and energy balances that illustrate the technico-economic relevance of the carbon sequestration and dry reforming process.

Three scenarios were considered: (a) dry reforming of methane, (b) dry reforming of methanol (CH₃OH) which is illustrated by the following equation:
2CH₃OH_{(g)}+CO_{2(g)}→2CO_{(g)}+2H_{2(g)}+2H₂O_{(g)}+C₍ₛ₎ (4)
and (c) waste gasification followed by a dry reforming. Tables 3 to 5 report the mass and energy balance results for the three scenarios. Table 4 contains similar information than Table 3 but all reported per 100 kilograms of fuel.

In all cases the energy efficiency of the combined reforming and carbon sequestration process is higher than 63 mol %. This means that the sequestration costs are approximately one third of the energy content of the fuel.

TABLE 3

| | CH₄ | CH₃OH | Gasification |
|---|---|---|---|
| | reforming | reforming | and Reforming |
| Fuel input (kg) | 2.7 | 6.1 | 14.5 |
| CO₂ input (kg) | 7.4 | 3.8 | 5.1 |
| Carbon output (kg) | 2.0 | 1.0 | 1.4 |
| Energy input (MJ) | 149.9 | 124.1 | 261.1 |
| Reforming losses (MJ) | 14.7 | 9.46 | 14.7 |
| Energy output gas (MJ) | 95.8 | 97.2 | 166.4 |
| Energy output C (MJ) | 66.3 | 34.4 | 46.0 |
| Efficiency | 63.9 | 78.3 | 63.7 |
| Energy per kg sequestered C | 7.3 | 9.0 | 10.5 |
| (MJ/kgC) | | | |
| Energy per ton CO₂ sequestered | 1984 | 2460 | 2854 |
| (MJ/ton CO₂) | | | |
| Cost ($CDN/ton CO₂) | 17.5 | 21.7 | 25.1 |

TABLE 4

| | CH₄ | CH₃OH | Gasification |
|---|---|---|---|
| | reforming | reforming | and Reforming |
| Fuel input (kg) | 100 | 100 | 100 |
| CO₂ input (kg) | 275 | 62.5 | 35.5 |
| Sequestered carbon output (kg) | 75.0 | 17.1 | 9.7 |
| Energy input (MJ) | 5565 | 2018 | 1804 |
| Reforming losses (MJ) | 545.7 | 153.9 | 101.4 |
| Energy output gas (MJ) | 3556 | 1580 | 1150 |
| Energy output C (MJ) | 2460 | 559 | 318 |
| Efficiency | 63.9 | 78.3 | 63.7 |
| Energy per kg sequestered C | 7.3 | 9.0 | 10.5 |
| (MJ/kgC) | | | |
| Energy per ton CO₂ sequestered | 1984 | 2460 | 2854 |
| (MJ/ton CO₂ | | | |
| Cost ($CDN/ton CO₂) | 17.5 | 21.7 | 25.1 |

TABLE 5
1. For electrical energy production

| | | |
|---|---|---|
| Carbon HHV | 33 | MJ/kg |
| Equivalent energy in kWh electric (combined cycle) | 4.6 | kWh |
| Cost of electricity production | 0.04 | US$/kWh |
| Break-even price of sequestered carbon | 0.183 | US$/kg C |

2. For steam production

| | | |
|---|---|---|
| Carbon HHV | 33 | MJ/kg |
| Cost of equivalent steam | 0.004 | $/MJ |
| Break-even price of sequestered carbon | 0.132 | $/kg C |

A promising application of the carbon sequestration and dry reforming process is shown schematically in FIG. 5 which describes the application of the carbon sequestration and dry reforming process in a waste gasification industrial unit.

The waste gasification is a process that chemically and physically changes biomass 118. Gasification uses heat, pressure, and steam to convert biomass 118 such as coal, petroleum-based materials, and organic materials. The biomass 118 is prepared and fed, in either a dry or slurried form, into a sealed reactor chamber called a gasifier 122. The feedstock is subjected to high heat, atmospheric or higher than atmospheric pressure, and either an oxygen-rich or air environment within the gasifier. Oxygen-enriched air or air 124 can be added to the gasifier 122. In all cases the amount of the oxygen used is typically lower than 40% of the stoichiometric quantity. The end products 126 of gasification include hydrocarbon gases, mainly syngas, but also other hydrocarbons, and char (carbon black and ash). Solid residues 127 of the end products 126 are removed in a cyclone 128 and a filter 130. The end products 126 can be subsequently purified in a purifier 132 to remove fine particles, tar and contaminants in small quantities, such as HCl, SOₓ, HCN, NH₃ and the like, and obtain a reactant gas mixture 140.

The reactant gas mixture 140 is then injected in a reactor 120, which in the present example is a fluidized bed, wherein the hydrocarbon gas are dried reformed, leaving a carbon deposit on the 2D catalyst. The product gas mixture 142 obtained after the carbon sequestration and dry reforming process includes a higher proportion of syngas than the reactant gas mixture 140 and less carbon dioxide. The sequestered carbon is released from the catalyst particles due to the friction between the particles in the fluidized bed. The carbon released 143 is recovered with the gas. A solid-gas separation can be carried out with a cyclone 128. Syngas is used as an energy vector. It can be burned in a burner 144 as a fuel source and generate electricity 146 with a gas turbine 148 and used to boil water 150 in a boiler 152 to generate steam 154. It can be also used directly in solid oxide fuel cells, as will be illustrated below, or in other fuel cells after a step of hydrogen purification.

### Example 5

The following example relates to the dry reforming of methane in the presence of two catalysts: a 3D low porosity zirconia/alumina supported Ni catalyst (Ni/ZrO₂—Al₂O₃ composite catalyst) for dry reforming of methane followed by a 2D thermally activated carbon steel catalyst for carbon sequestration. The following equations are the dry reforming reaction, the Boudouard reaction and the CO reduction by H₂:
CH_{4(g)}+CO_{2(g)} [symbol] 2CO_{(g)}+2H_{2(g)} (5)
CO_{(g)} [symbol] ½CO_{2(g)}+½C₍ₛ₎ (6)
H_{2(g)}+CO_{(g)} [symbol] H₂O_{(g)}+C₍ₛ₎ (7)
Preparation of the Catalysts

For the preparation of the Ni/ZrO₂—Al₂O₃ composite catalyst the first step was the preparation of the zirconia/alumina support. Al₂O₃ powder having a particle size of approximately 10 nanometers was mixed with the powder of 7% YO₂-stabilized ZrO₂ having a particle size less than approximately 20 μm. For the preparation of a typical cylindrical pellet, three hundred milligrams of each powder were mixed and pressed at 2670 atm (40 000 psi or 276 MPa) for 5 minutes. The pellet was then heated at 1 400° C. for 16 hours at a heating rate of 5° C. per minute to solidify the pellet and reduce its porosity.

The second step was the deposition of nickel at the surface of the pellet by impregnation. A pre-calculated amount of the metal precursor Ni(NO₃)₂.6H₂O was used to prepare an aqueous impregnation solution with the following amounts of materials: 10 g of Ni(NO₃)₂.6H₂O, 5 grams of H₂O, 0.3 gram of Al₂O₃ and 0.3 gram of ZrO₂. The solution was stirred during 24 hours and a solid was removed from the saturated solution and dried. The solid was then calcined with air at 500° C. for six (6) hours with a temperature ramp rate of 5° C. per minute to obtain the 3D composite catalyst.

Before its use, the 3D catalyst was reduced in situ under a pure hydrogen flow during 60 minutes at 500° C. Then the temperature was increased up to the reaction temperature under pure nitrogen flow.

The composite catalyst obtained was a 3D catalyst for dry reforming of methane with a minimum sequestration of carbon.

The second catalyst were steel shavings that were used as 2D catalysts to perform the Boudouard and CO reduction reactions (reactions 6 and 7) in the second part of the reactor or in a second reactor. The carbon steel catalysts were activated at 830° C. under a nitrogen atmosphere containing ˜1% of oxygen for one hour. The eutectic temperature of the steel is at 723° C. and the objective was to transform all the steel in its alpha phase.

Heating the 3D reforming catalysts under a pure nitrogen flow prior to beginning the carbon sequestration and dry reforming process prevents the oxidation of the reactive surfaces of the catalysts and the formation of undesirable carbon that would occur if the reactor was fed with the reactant gas mixture during the catalyst heating phase.

### Experimental Setup

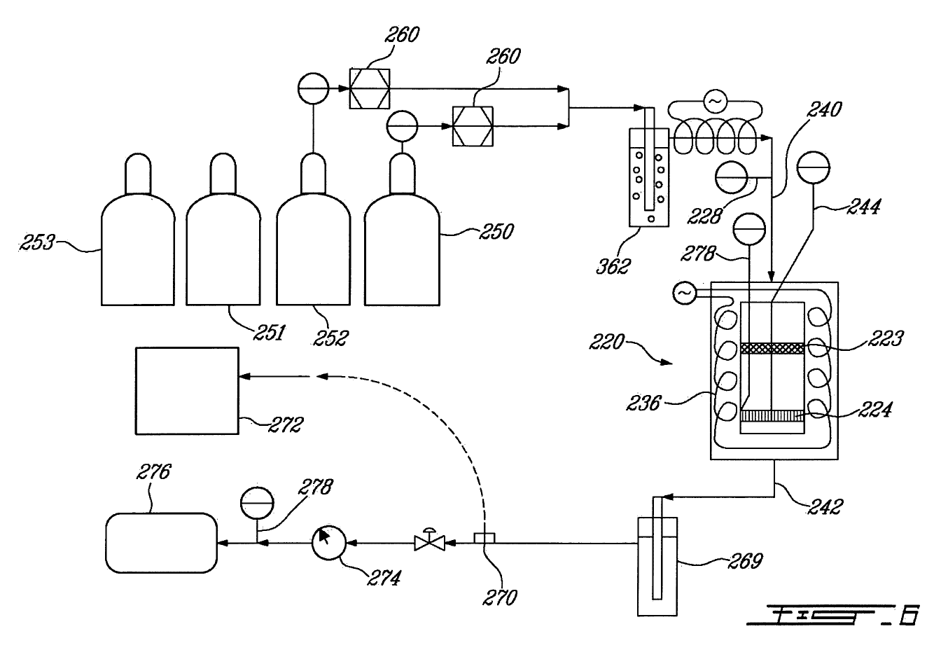

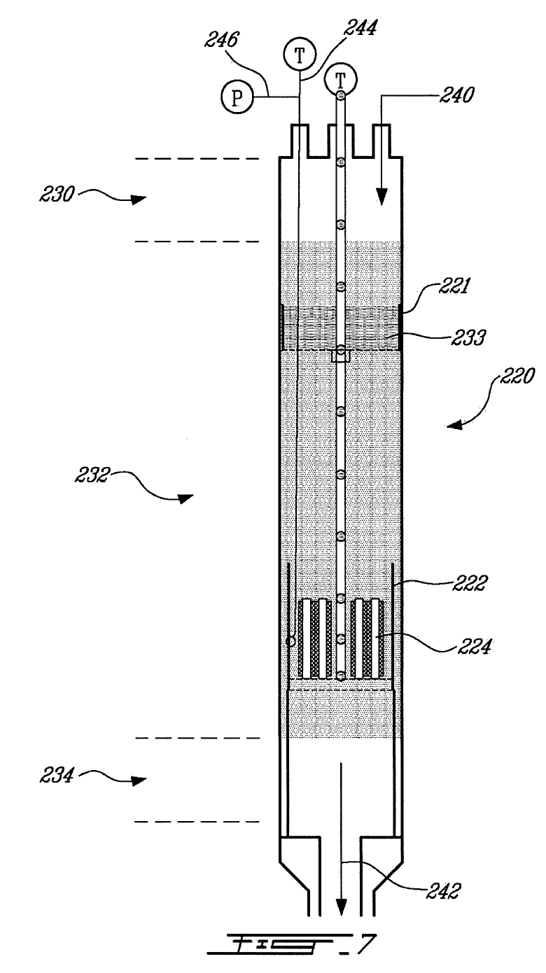

Referring to FIGS. 6 and 7, it will be seen that the experimental setup started with four gas cylinders 250, 251, 252, and 253. The first gas cylinders 250 contained CO₂, the second gas cylinder 251 contained hydrogen, the third gas cylinder 252 contained methane, and the fourth gas cylinder 253 contained nitrogen. Hydrogen was used to reduce the 3D composite catalyst as described above. Nitrogen was used to avoid the oxidation of the catalysts. Two rotameters 260 were used to measure the gas flow. The gas chromatograph 272 (GC) was used to obtain a higher precision of the inlet molar ratio of methane to carbon dioxide ([CH₄]/[CO₂]). The reactant gas mixture 240 passed through a heat controlled stirrer 262 for humidification of the gas to its saturation. Saturation was obtained with a decrease of the gas temperature that followed the stirrer 262. A thermocouple 244 measured the gas temperature before it enters into the reactor 220. At this point, the reactant gas mixture 240 was supposed to be fully mixed.

The reactor 220 included an upper catalyst table 221 and a lower catalyst table 222, each having a catalyst fixed bed disposed thereto. The upper catalyst table 221 contained the reformer catalyst (Ni/ZrO₂—Al₂O₃ composite catalyst) fixed bed 223 and the lower table 222 contained the carbon deposition catalyst (steel shavings) fixed bed 224.

The reactor 220 was longitudinally divided into three portions: an upper portion 230, a middle portion 232, and a lower portion 234. The upper and lower portions 230, 234 were not heated while the middle portion 232 was provided with three independent controlled heating elements 236 (only one is shown). These three heating elements 236 allowed an optimization of the temperature for both reactions and allowed rapid temperature changes. A thermocouple 244, which takes the temperature at ten (10) points along the reactor, was disposed in the center of the reactor 220. The thermocouple 224 allowed an accurate monitoring of the temperature profile in the reactor and control of the latter to follow a predetermined temperature profile by actuating the heating elements 236.

The product gas mixture 242 withdrawn from the reactor 220 was allowed sufficient time to cool down before being dried (for the GC test) with a molecular sieve (3 Å) 269. Following the molecular sieve 269, a septum 270 was used for sampling the product gas mixture 242 for GC analyses. The remaining product gas mixture 242 was measured with a volume flow meter 274 and accumulated in a collector bag 276.

As for the experimental set-up shown in FIGS. 1 and 2, one skilled in the art will appreciate that the experimental set-up can contain a plurality of sensors 278 such as thermocouples and pressure gages.

The whole experimental setup was built with stainless steel 316 except the stirrer 262 and the molecular sieve jar which were built in glass.

Once introduced into the reactor 220, the reactant gas mixture 240 went down and was heated while going down until the first reaction temperature was reached. Thereafter, the reactant gas mixture 240 was passed through the 3D catalyst fixed bed 223 where it was reformed. Then, the reformed gas mixture went down, reached the second reaction temperature, and was passed through the 2D catalyst fixed bed 224 leaving a carbon deposit (not shown) superficially on the 2D catalyst. The product gas mixture 242 exited at the lower portion 234 of the reactor 220. The product gas mixture 242 was mainly composed of carbon monoxide, hydrogen, and water.

Catalytic Test and Results

The dry reforming of methane was performed at 730° C. during 150 minutes with a carbon dioxide (CO₂) flow of 16.5 ml/minute and 1.2 ml/minute of steam. The molar ratio of methane to carbon dioxide and steam ([CH₄]/[CO₂]/[H₂O]) in the reactant gas mixture 240 was equal to 45/55/4. 0.6 gram of the 3D Ni/ZrO₂, Al₂O₃ catalyst and 10 grams of 2D steel catalyst were used. In the same reactor, the Boudouard and CO reduction reactions took place at a temperature of 500° C. No sample was taken between the reforming reaction and the carbon deposition reactions. Table 6 shows the composition of the product gas mixture 242 after 150 minutes of reaction.

TABLE 6

| | H₂ | CO | CH₄ | CO₂ |
|---|---|---|---|---|
| Gas (mol %) | 42.4 | 16.2 | 12.2 | 29.2 |

Table 7 shows the yield of hydrogen, carbon and carbon monoxide formed during the reaction and the conversion of methane and CO₂. The hydrogen yield was calculated as the ratio of hydrogen (in moles) measured in the product gas mixture 242 to the hydrogen introduced with the reactant gas mixture 240 as methane and water. The carbon yield was determined by the ratio of carbon (in moles) formed in the reactor 220 to the carbon introduced as CO₂ in the reactant gas mixture 240. Thus a unit hydrogen yield means that all hydrogen contained in the CH₄ and water was recovered as H₂ (100 mol % recovery) and a unit carbon yield means that all carbon in CO₂ is recovered as solid carbon (100% molar sequestration). The yield of carbon monoxide (CO) is defined as the ratio of the CO (in moles) measured in the product gas mixture 242 to the CH₄ (in moles) in the reactant gas mixture 240. The carbon yield (C) is calculated as the percentage of the converted CO₂ which ended-up as solid carbon. The percentage of conversion for CH₄ is:

$$( 1 - \frac{{CH}_{4} in the product gas mixture}{{CH}_{4} in the reactant gas mixture} ) * 100.$$

The percentage of CO₂ conversion is calculated in the same manner.

TABLE 7

| | CH₄ | CO₂ | H₂ | CO | C |
|---|---|---|---|---|---|
| Conversion or Yield | 75.4 | 44.2 | 49.6 | 43.4 | 68.7 |
| (mol %) | | | | | |

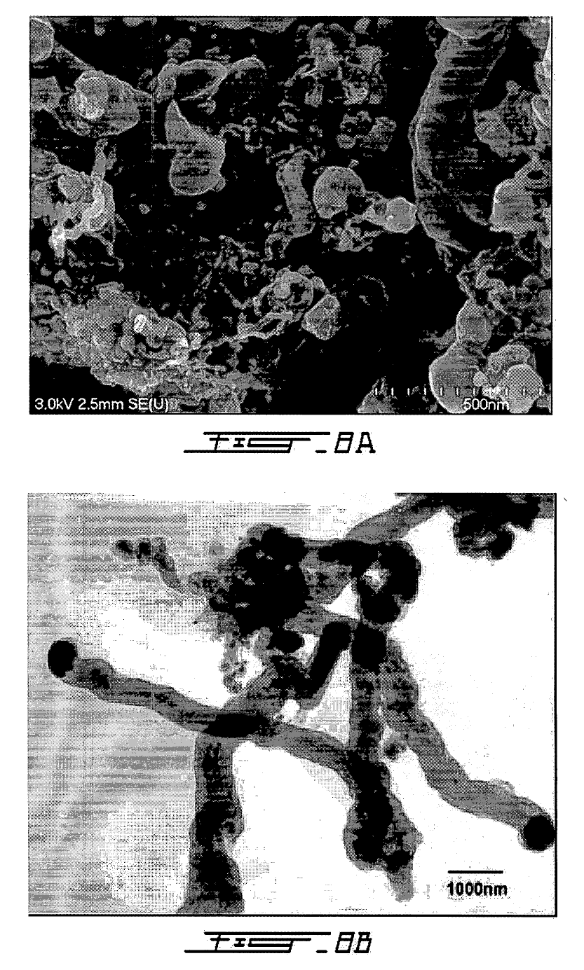

0.834 gram of carbon were obtained with 0.6 gram of reforming catalyst and a surface of less than one square meter of carbon formation catalyst. The sequestered carbon was analyzed by electron microscopy to identify its structure. FIGS. 8a, 8b, 8c, and 8d show the presence of a mixture of carbon whiskers and other similar filamentous structures.

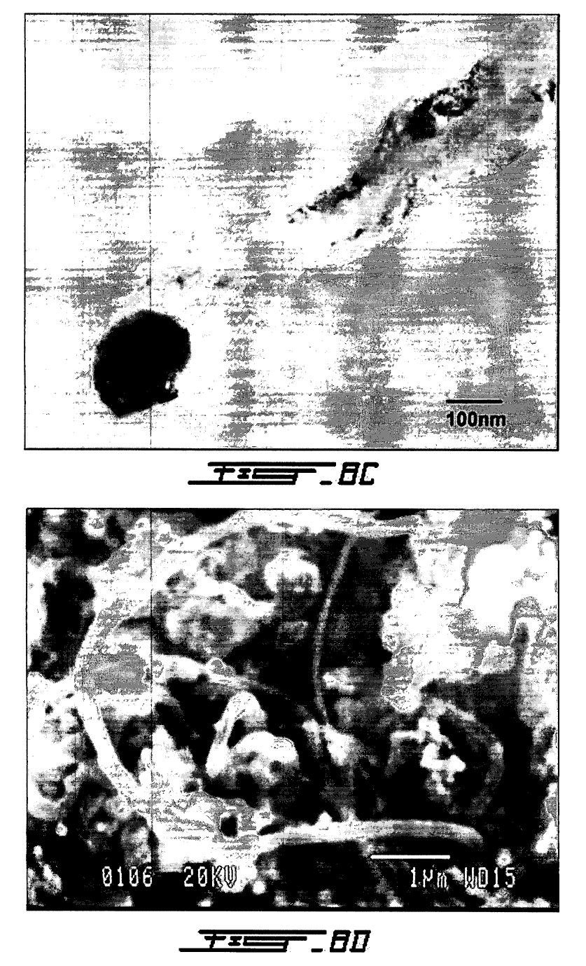

Referring to FIG. 9, it will be seen that elementary analysis showed the presence of iron in the carbon sample. With a transmission electronic microscope, the iron was found in a particle form included in the filament. The other elements, i.e. silicon and copper, were part of the sample support. The particle was substantially nickel free.

### Example 6

Mass balances were realized on three experiments with data obtained from the GC 272 and volume flow meter 274. The ratio of CH₄ and CO₂ was determined with the GC as the product gas mixture concentration. The volume flow meter 274 measured the volume of the product gas mixture 242 for the entire experiment. The reactant gas mixture flow was estimated with the two rotameters 260 and was corrected with the data provided by the GC 272 and the volume flow meter 274. The steam saturated the reactant gas mixture 240. The volume of the reactant gas mixture 240 was evaluated at the coldest temperature reached (considering a saturated gas: if its temperature decreases, the steam condensates and the liquid water drips). The mass balance was satisfactory when the closure was higher than 95% for the overall, the carbon, and the oxygen mass balances. The hydrogen mass balance usually does not have the satisfactory precision for hydrogen concentrations higher than 35% due to the GC sensitivity.

Tables 8 and 9 show the results of a first experiment that was carried out with a catalyst. A non porous 2D catalyst obtained by impregnation of nickel on a zirconia-alumina matrix was used for both carbon sequestration and dry reforming. The reforming was carried out at 730° C. and the Boudouard reaction was carried out at 500° C. The reactant gas mixture ratio ([CH₄]/[CO₂]/[H₂O]) was 0.82/1/0.08.

The test was carried out during 150 minutes. The gas reactant mixture content and flow is shown in Table 8.

Table 9 shows the mass balance results with the percentage of conversion of the different components. In Table 9, the conversion from volume to mole was done with the perfect gas equation at atmospheric pressure and 25° C.

TABLE 8

| | | |
|---|---|---|
| Duration | 150 | minutes |

Inputs

| | | |
|---|---|---|
| Gas flow | 29.5 | |
| CH₄ | 13.3 | ml/min |
| CO₂ | 16.2 | ml/min |

Outputs

| | | |
|---|---|---|
| Start | 1273.8 | |
| End | 1278.4 | |
| Volume | 4.56 | L |
| Total | 4.85 | L |
| Water | 0.86 | gram |
| Carbon | 0.83 | gram |

TABLE 9

| | Input | | | Output | | | Conver- |
|---|---|---|---|---|---|---|---|
| Species | Volume | | Mass | Volume | | Mass | sion |
| Unit | liter | Moles | gram | liter | Moles | gram | Yield (%) |
| CO₂ | 2.43 | 0.10 | 4.38 | 1.38 | 0.06 | 2.48 | 43.3 |
| CH₄ | 1.99 | 0.08 | 1.30 | 0.50 | 0.02 | 0.33 | 75.0 |
| CO | 0 | 0 | 0 | 0.88 | 0.04 | 1.00 | 19.9 |
| H₂ | 0 | 0 | 0 | 2.10 | 0.09 | 0.17 | 50.5 |
| H₂O | — | 0.01 | 0.13 | — | 0.05 | 0.86 | 47.8 |
| Carbon | — | 0 | 0 | — | 0.07 | 0.83 | 69.9 |
| C | — | 0.18 | 2.17 | — | 0.18 | 2.19 | 0.7 |
| O | — | 0.21 | 3.30 | — | 0.20 | 3.14 | −4.8 |
| H | — | 0.34 | 0.34 | — | 0.35 | 0.35 | 2.4 |
| Total | | | 5.81 | | | 5.67 | −2.3 |

Tables 10 and 11 show the results obtained in a second test performed in similar conditions. A low porosity catalyst obtained by impregnation of nickel on a zirconia-alumina matrix was used for both carbon sequestration and dry reforming. The reforming and the Boudouard reaction were carried out at 730° C. The reactant gas mixture ratio ([CH₄]/[CO₂]/[H₂O]) was 1/1/0.08.

The test was carried out during 126 minutes. The gas reactant mixture content and flow is shown in Table 10.

TABLE 10
The mass balance for the reforming test

| | | |
|---|---|---|
| Duration | 126 | minutes |

Inputs

| | | |
|---|---|---|
| Gas flow | 30.6 | |
| CH₄ | 15.2 | ml/min |
| CO₂ | 15.4 | ml/min |

Outputs

| | | |
|---|---|---|
| Start | 1285.4 | |
| End | 1289.5 | |
| Volume | 4.07 | L |
| Total | 4.32 | L |
| Water | 0.75 | gram |
| Carbon | 0.65 | gram |

TABLE 11

| | Input | | | Output | | | Conver- |
|---|---|---|---|---|---|---|---|
| Species | Volume | | Mass | Volume | | Mass | sion |
| Unit | liter | Moles | gram | liter | Moles | gram | Yield (%) |
| CO₂ | 1.94 | 0.08 | 3.49 | 1.06 | 0.04 | 1.91 | 0.45 |
| CH₄ | 1.92 | 0.08 | 1.25 | 0.59 | 0.02 | 0.39 | 0.69 |
| CO | 0.00 | 0.00 | 0.00 | 0.88 | 0.04 | 1.01 | 0.23 |
| H₂ | 0.00 | 0.00 | 0.00 | 1.78 | 0.07 | 0.15 | 0.45 |
| H₂O | — | 0.01 | 0.11 | — | 0.04 | 0.75 | 0.53 |
| Carbon | — | 0.00 | 0.00 | — | 0.05 | 0.65 | 0.68 |
| C | | | | | | | |
| O | — | 0.16 | 1.89 | — | 0.16 | 1.89 | 0.00 |
| H | — | 0.16 | 2.63 | — | 0.16 | 2.63 | 0.00 |
| Total | — | 0.33 | 0.33 | — | 0.33 | 0.33 | 0.00 |

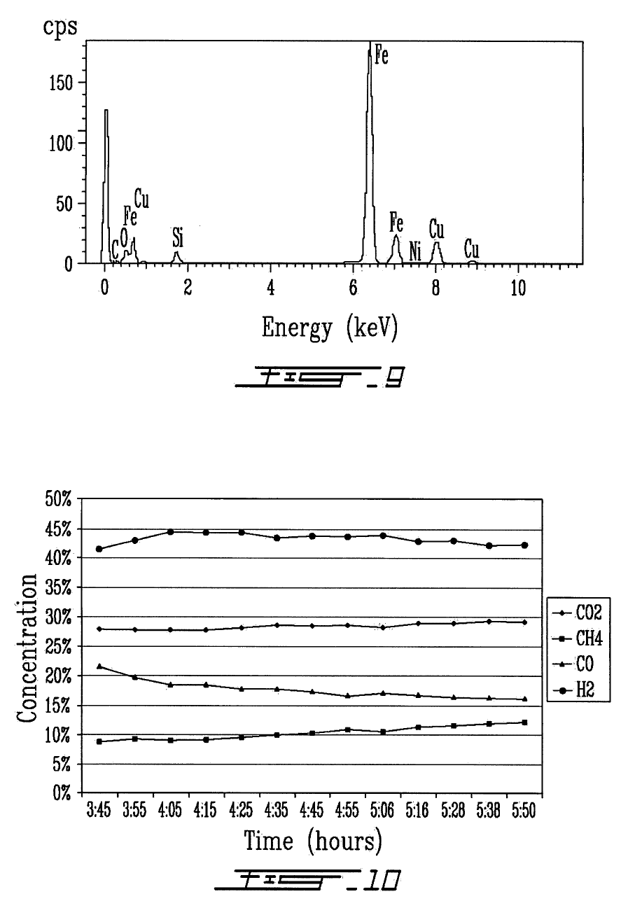

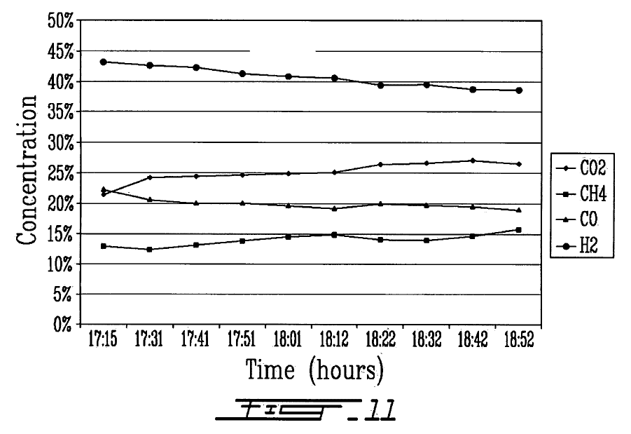

FIGS. 10 and 11 show the time evolution of the gas concentration respectively for the first and the second experimentations described above. FIG. 10 relates to the test results shown in Tables 8 and 9 and FIG. 11 relates to the test results shown in Table 10 and 11. The increase of the methane and CO₂ concentrations and the decrease of the H₂ and CO concentration over time can be seen as a reforming catalyst deactivation. An increase of the Boudouard reaction over time was observed, creating an increase of the CO consumption and the CO₂ production.

The nucleation of the filaments is a more difficult process than the growth of the filaments. Therefore, at the beginning of the experimentations, no filament was formed and, consequently, the CO consumption was low. At the end of the experimentations, several filaments were growing simultaneously and the CO consumption was higher than at the beginning of the experimentation. Moreover, the temperature was not optimized in these experimentations and a portion of the carbon was transformed in methane by the hydrogen contained in the product gas mixture 242.

### Example 7

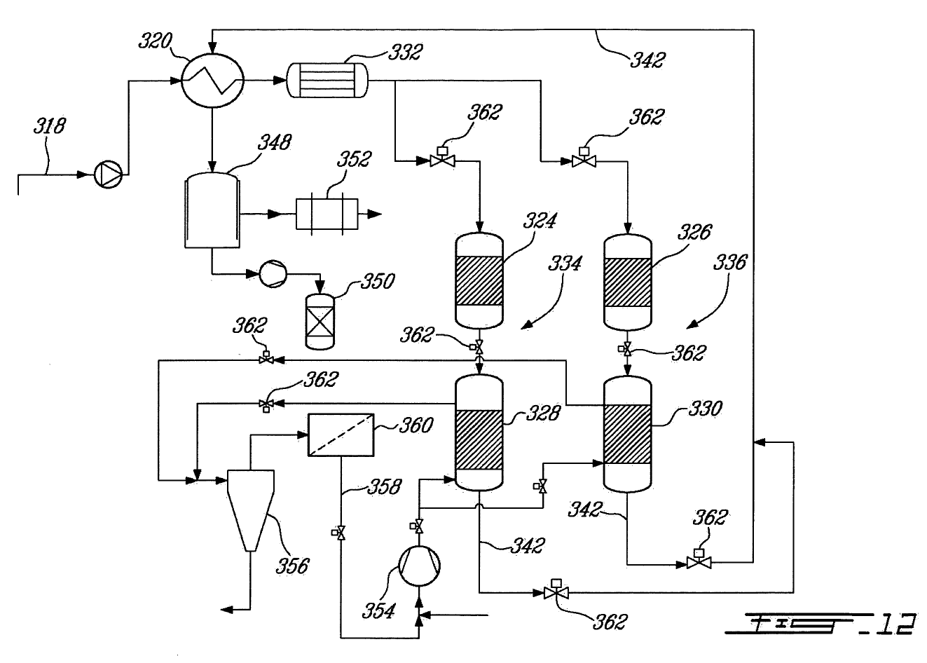

Referring now to FIG. 12, it will be seen another embodiment of the dry reforming process adapted for an industrial process.

A biogas source 318 (e.g. a landfill gas), containing an organic material and carbon dioxide in gaseous phase, is provided. The biogas 318 is first heated in a first heat exchanger 320 by recovering heat contained in the product gas mixture 342 produced by the reactors 324, 326, 328, and 330, as will be described in more details below. The biogas 318, exiting from the first heat exchanger 320, can be further heated in a second heat exchanger 322. The heated biogas 318, or the reactant gas mixture, then flows to one of the two parallel reactor lines 334, 336. One skilled in the art will appreciate that any number of parallel reactor lines 334, 336 can be provided. Each reactor line 334, 336 includes two reactors 324, 326, 328, and 330, which can be either fixed or fluidized bed reactors, in series. One skilled in the art will appreciate that the reactor line 324, 326 can include only one reactor which performs both dry reforming and carbon sequestration operations.

On FIG. 12, the first reactor 324, 326 of a reactor line 334, 336 includes a 3D reforming catalyst while the second reactor 328, 330 of a reactor line 334, 336, following the first reactor 324, 326, includes a 2D carbon sequestration catalyst.

The reactor lines 334, 336 are operated in an alternative mode for providing a continuous carbon sequestration and dry reforming of the biogas 318: one reactor line is operated in catalyst regeneration mode and the other line is operating in carbon sequestration and gas reforming mode, thus insuring uninterrupted continuous operation. The catalyst regeneration can be carried out with any appropriate technique known to one skilled in the art.

The product gas mixture 342 resulting from the reactor line operating in carbon sequestration and gas reforming mode is recovered and sent to the first heat exchanger 320 for pre-heating the biogas 318. Once cooled down, the product gas mixture can be sent to a tank 348 for being transferred to a catalytic synthesis reactor for liquid fuels 350, a power generator 352, or any other desired apparatus.

The air stream generated by a blower 354 is used to remove mechanically the multiwall nanotubes (MWNT) sequestered on the 2D catalyst. The MWNT removed by the air stream are sent through a cyclone 356 or other gas/solid separators, such as an electrostatic precipitator, to retain all MWNTs with an average size higher than 10 □m, for example. The air stream 358 leaving the cyclone 356 carries all particles with an average size lower than 10 □m, for example, and is sent through a baghouse 360, or other type of cold gas filters, to retain all remaining MWNTs. The air stream 358, thus scrubbed out from solids is released or brought back in a closed-loop including the blower 354 to the catalyst unloading process described above. As one skilled in the art will appreciate the process can include a plurality of valves 362 to control the flow into the conduits.

In an embodiment, the reactant gas mixture can contain a mixture of CH₄ and CO₂ in a molar ratio ranging between 1/3 and 3/1. The reactant gas mixture is preferably preheated to a temperature ranging between 700-750° C. and is fed in a first catalytic reactor which contains the 3D reforming catalyst. The composition of the catalysts that can be used are described above. A quantity of gaseous water ranging from 0 to 10 wt % of the reactant gas mixture can be added to the reactant gas mixture.

In the first catalytic reactors 324, 326, the reactant gas mixture is reformed to a gas containing CO and H₂. In the first reactors 324, 326, small quantities of undesired carbon are formed at the surface of the 3D catalyst, which is typically less than 1 wt % of the carbon fed into the reactors 324, 326. The carbon released at the surface of the 3D catalyst is responsible for a gradual catalyst deactivation. Therefore, as mentioned above, it is preferable to have two reactor lines 334, 336 wherein one line is operated in catalyst regeneration mode and the other line is operating in carbon sequestration and gas reforming mode, thus insuring uninterrupted continuous operation. The 3D catalyst regeneration can be carried out with steam reforming, slow partial oxidation conditions or any other appropriate technique known to one skilled in the art. As mentioned above, a flow sheet including at least two parallel reactor lines 334, 336 is preferable to insure on-line recovery of the carbon filaments formed at the surface of the 2D carbon sequestration catalyst without interrupting the continuous reforming and carbon sequestration process.

The gas mixture exiting from the first catalytic reactors 324, 326 is fed into second catalytic reactors 328, 330 containing the 2D carbon sequestration catalyst. A percentage of the carbon contained CO/H₂ mixture is converted into inert solid carbon under filamentous multiwall nanotubes form.

Several applications can be foreseen for the carbon sequestration and dry reforming process. For example, without being limitative, the carbon sequestration and dry reforming process can be applied to recycle the exhaust gases from fuel cells to extract the solid carbon and obtain an ecological fuel cell, even if a fossil fuel is used.

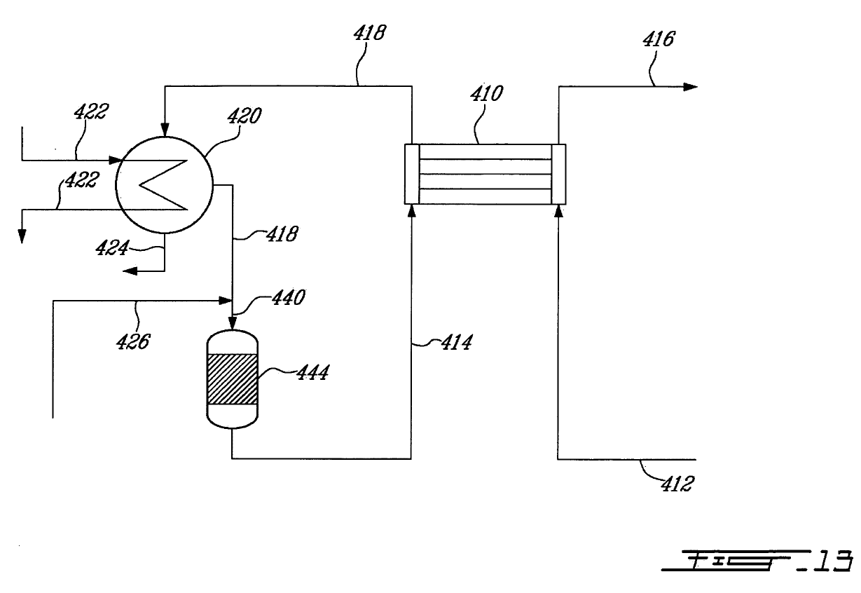

For example, referring to FIG. 13, it will be seen a schematic flow sheet of the combination of the carbon sequestration and dry reforming process with a solid oxide fuel cell 410. Air 412 and CO₂ reformed fuel 414 are injected in the solid oxide fuel cell 410 and depleted air 416 and a mixture of CO₂, fuel and water 418 are withdrawn. The CO₂ reformed fuel is the product gas mixture of the dry reforming and carbon sequestration as will be described in more details below. The mixture of CO₂, fuel and water 418 withdrawn is then processed into a heat exchanger 420 with a cooling fluid 422 for cooling down the mixture 418 and withdrawing a percentage of the water 424 contained therein. Extra fuel 426 can be added to the cooled down mixture 418 to form the reactant gas mixture 440. The reactant gas mixture 440 is introduced into a reactor 444 for dry reforming and carbon sequestration, as described in more details above. A product gas mixture 414 is withdrawn from the reactor 444 and injected into the solid oxide fuel cell 410 as the CO₂ reformed fuel.

### Example 8

The following example relates to the dry reforming process using low-carbon steel activated with heat under oxidizing conditions (FeₓC and Fe_{y}O_{z} catalysts).

### 8.1 Experimental Materials

The experimental carbon steel, grade 1008, was supplied by Technologie Supérieure d'Alliages. It had a carbon content of 0.06% C and Mn impurity of 0.29%, along with traces of P, S, Cu, Ni, Cr, Nb, Mo, N, Sn and Ti, with a total of around 0.23%). The steel pellets were cut by laser. Ethanol used was supplied by Commercial Alcohols Inc. and has a purity of 99.9%. All gases employed were supplied by Praxair, the purity of gases being 99.996% for CO₂, 99.9999% for Ar and 95.88%-4.12% for the mixed Ar—H₂. Iron and magnetite powders were supplied by Alfa Aeser. The iron sample, item #00170, had spherical grains of less than 10 μm and a purity of 99.9%. The magnetite was CAS 1317-61-9, the grain size being less than 325 mesh (44 μm and less) and of 97% purity.

### 8.2 Experimental Method

The isothermal differential reactor was loaded with the catalyst pellet and was fed with the appropriate gas mixture while the temperature programmed furnace was heated up. For runs performed with non-pretreated carbon steel the temperature was raised at the set point under an Argon gas flow of chromatography purity. On reaching the operating temperature, the reactant gas mixture was fed to the reactor (6.6% Ethanol, 2.2% CO₂ and 91.2% Ar in volume). The reforming test was carried out for approximately 3 h. The reaction gas was distributed equally among the 7 quartz reaction chambers such that different catalysts could be simultaneously tested under identical conditions (gas flow, pressure, temperature), one reactor chamber being kept without catalyst (blank experiment). The gas compositions and flow rates were controlled by rotameters (OMEGA). The flow rate used was 25 ml/min per tube. Steel sheet, of 1.6 mm in thickness, was cut into circular pellets, 12.7 mm in diameter, and thence packed into the inner quartz tubes, being retained there by a pad of quartz wool. The inner tubes included porous fused quartz disks (of coarse porosity, 40-90 μm, and 1.5 cm diameter).

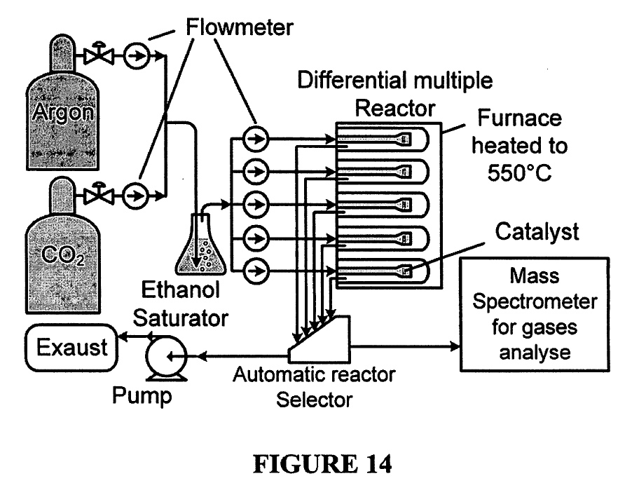

An Ethanol vapor/CO₂ gas mixture of molar ratio 3/1 was chosen in order to maintain an excess of carbon over oxygen aimed at maximizing the carbon formation. The operating temperature chosen, 550° C., is the theoretical optimal temperature for carbon formation according to the Gibbs energy minimization for the ethanol dry reforming calculation and the published information regarding the Boudouard reaction on iron (Rostrup-Nielsen et al. 2002, Advances in Catalysis, 47, 65-139; Tibetts 1983, Applied Physics Letters 1-26, 42(8), 666-668. The product gases from each reactor cell were sampled in a “round-robin” sequence, using a computer-controlled valve assembly (Valco), the recovered gas samples being then directed to the quadrupole mass spectrometer (Balzers QMG-420) for identification. The magnitudes of these measurements were calibrated using pure standard gases, diluted to appropriate levels in the Ar carrier gas. The accuracy of the analysis was within ±3% and the reproducibility was ±2%. The experimental set-up utilized is displayed in FIG. 14.

### 8.3 Catalyst Characterization

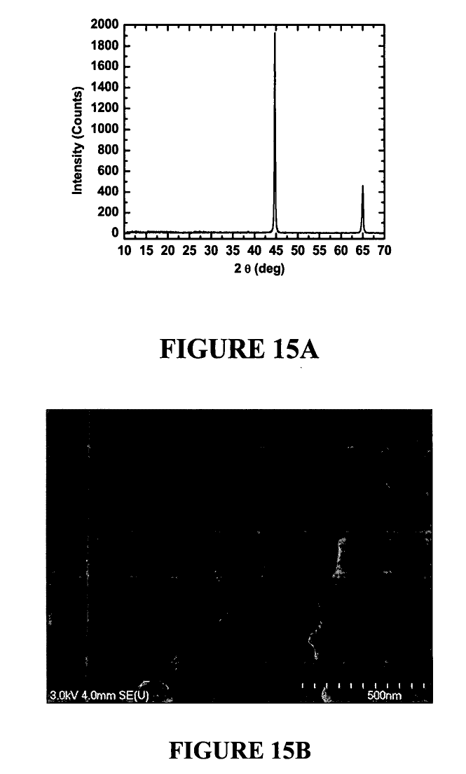

The pictures shown in FIGS. 15-19 were taken with the use of a Field Emission Gun Microscope, Hitachi S-4700 (FEG). XRD (X-Ray Diffraction) data were obtained by means of a Panalytical X'pert PrO diffractometer, using CuKα radiation at room temperature, along with instrumental settings of 45 kV and 40 mA and was used particularly to detect crystalline phases present in the carbon steel catalyst. The BET (Brunauer-Emmett-Teller) method was used to measure the specific surface of the oxides, this measurement being made at 77 K using a Quantachrome Autoasorb 1, assuming a 0.162 nm² cross-sectional area for N₂.

Results and Discussion:

### 8.4 Fresh Steel

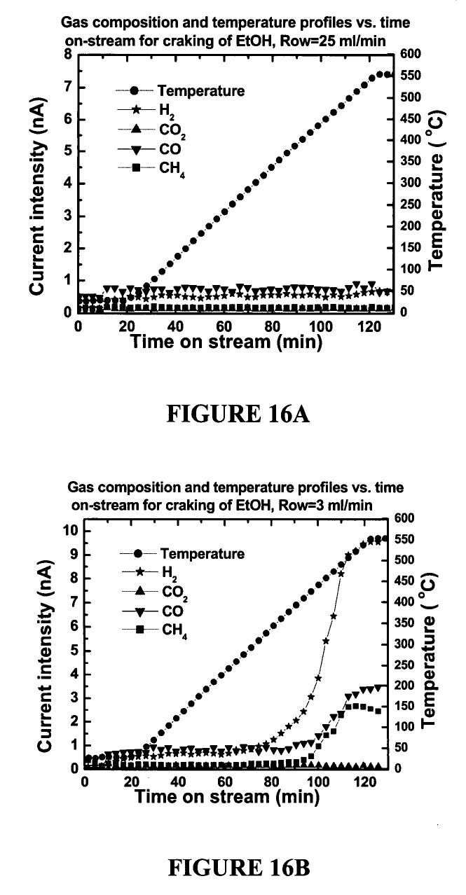

In the first measurements, we used the steel in the “as purchased” condition. Its XRD analysis, recorded at ambient temperature, displayed only peaks due to presence of iron of uniform morphology (FIGS. 15A and 15B). At 550° C., no reforming or decomposition reaction was observed and no detectable carbon was deposited. Traces of deposited carbon, observed by the FEG, were present in a rather amorphous, non-organized state but nanotube or filamentous forms were not found. In respect of gas production, the result was very similar to the blank test, performed at 550° C. and at a flow of 25 ml/min (FIG. 16A). The reasons for this absence of activity are related to the low catalytic activity of the steel in this reaction (FIG. 15). Even if some catalytic activity exists, the reaction severity (mainly the space velocity and the temperature) is not sufficient to reach a significant extent of reforming reaction. The specific surface was not measured by the BET method but the FEG pictures (see smoothness of the surface shown in FIG. 15B) clearly showed that there was no internal porosity and that the surface can be measured essentially geometrically; the calculation indicating a specific surface of the order of 20 cm²/g.

### 8.5 The Reaction Conditions

The space velocity is an important parameter to be measured in any catalytic test and, in order to investigate under what conditions the thermal cracking process is possible, two experiments have been previously performed and reported in: “Abatzoglou et al. 2006, WSEAS Transactions on Environment & Development 2(1), 15-21; Abatzolgou et al. 2006, WSEAS Int. Conf. on Energy & Environmental Systems, Proceedings 21-26”, using this particular differential reactor set-up. The results of these experiments showed that, for the reforming conditions used in this test, no significant cracking or reforming activity, in the absence of catalysts, are detectable with a total flow of 25 ml/min per tube, while some activity is observed at a flow of 3 ml/min (from the reactor's volume, we calculate a GHSV of 750 h⁻¹ and 90 h⁻¹ respectively). FIG. 16B, taken from said publications, illustrates this point.

### 8.6 Activation of the Catalyst

A thermal treatment has been found to be necessary to activate the catalyst to promote the target reaction. The protocol of this activation treatment consists of the following 4 general steps:
Step 1: The steel is heated to 800° C. under a blanket of Ar of chromatographic purity and is then kept at this temperature for one hour;
Step 2: The thus treated steel is then cooled to 25° C. at a rate of 5° C./min;
Step 3: Exposure of the steel from step 2 to normal air for 24 h; and
Step 4: The steel from step 3 is reheated to 550° C. for the remaining 3 hour-reforming reaction.

The following reported experimental tests employed two catalyst samples which were then submitted to a “selection” of the above described 4 generic steps:

Catalyst 1 was not submitted to step 3 while Catalyst 2 was. The result is that Catalyst 1 was not in contact with oxygen before step 4, while Catalyst 2 was in contact with atmospheric oxygen at ambient temperature during step 3.

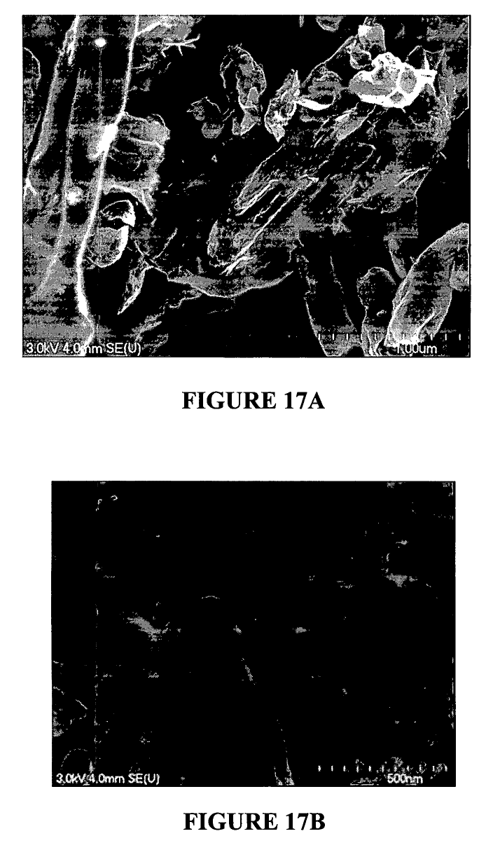

The results of the reforming test with the presence of Catalyst 1 demonstrated that decomposition of ethanol and carbon formation takes place at significant levels (see FIG. 17A). However, the carbon is not yet present in the form of nanofilaments and consequently, the thermal treatment performed under an inert atmosphere cannot account for either the entire catalytic activity during reforming or for the formation of carbon nanofilaments.

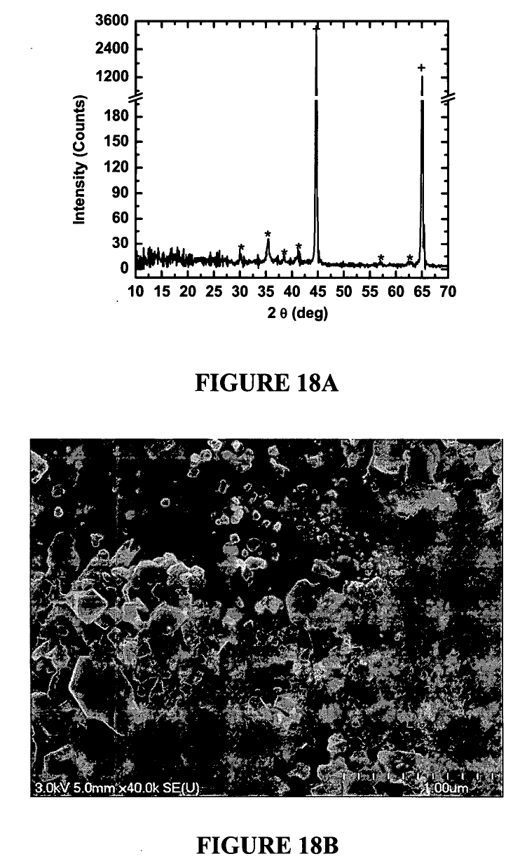

Catalyst 2 was analyzed using XRD after the reaction step 3 (exposure to the ambient atmosphere at room temperature). FIG. 18B shows that particles of Magnetite (Fe⁺²Fe₂⁺⁶O₄⁻⁸), as confirmed by means of DRX in FIG. 18A, appear on the surface of Catalyst 2. Magnetite cannot be formed during the thermal only treatment because there is no oxygen source available. This mixed oxide component appears after the treatment, and it is due to oxidation of the treated surface by ambient air before the X-ray and the FEG analysis. Thus the air oxidizes the steel after the thermal treatment and not before. This result can probably be explained by the fact that the low cooling rate (5° C./min) allows for the “restructuring” of the steel plate and the associated formation of small particles of the different phases of iron. These small particles are thenceforth responsible for the presence of higher specific surface, thus rendering the treated iron more readily oxidized compared to its untreated condition. Catalyst 2 was tested under the same dry reforming conditions over a 3 h period. The extent of the reforming reaction was the same as that found in the previous run with catalyst 1, but the carbon deposit formed was different from that obtained previously. Nanofilaments, with diameters ranging from 15 to 100 nm, and containing metal particles, were now present, as shown in FIG. 17B. Elemental analysis of the mechanically sampled (through rubbing) carbon revealed a weak signal for iron, confirming the role of magnetite in the formation of carbon nanofilaments. Moreover, as FIG. 18B shows, the range of the carbon filament diameters (from FIG. 17B) is close to the size range of the magnetite particles.

Two additional experiments (with catalysts 3 and 4) were included in order to investigate the magnetite's role in the reforming process and in carbon nanofilaments formation. Catalysts 3 and 4 were prepared, as follows:

Catalyst 3: Fresh steel surface was thermally pretreated using a specially adapted four step protocol. Step 1 was performed under reductive conditions (Ar=95.88% and H₂=4.12%) while step 3 was eliminated, thus avoiding all oxidative conditions before conducting the reforming process.

Catalyst 4: Same as Catalyst 3 with addition of step 3.

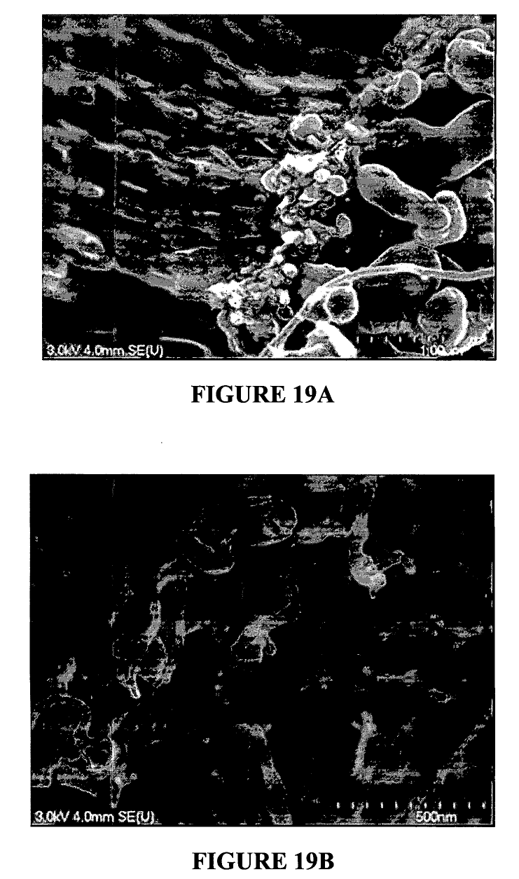

The FEG picture of FIG. 19A shows the surface of Catalyst 3 after its exposure to reforming conditions. The observed surface structure is similar to that obtained with Catalyst 1. The FEG picture of FIG. 19B shows the appearance of carbon nanofilaments on the surface of Catalyst 4. This is a qualitative, although clear, indication of the importance of the surface oxidation before the reforming step. For a better understanding of the role of iron surface oxidation, some additional experiments were subsequently carried out.

The previously obtained experimental results dictated the need for the testing of the pure iron and oxide powders for their catalytic activity under dry reforming conditions. Thus, powders of pure iron and pure magnetite have been tested for their promotion of ethanol reforming at 550° C. The BET test yielded values of specific surface of 0.34 m²/g for the iron and 7.20 m²/g for the magnetite. The powders were both pressed into pellets of 12.7 mm in diameter. To produce the iron pellet, 1.1 g of powder was pressed at 275 bars for 7 min. The magnetite pellets were obtained by pressing 0.525 g of the powder under the same conditions. The iron powder was named Catalyst 5 and the magnetite powder was named Catalyst 6. Catalysts 5 and 6 were not thermally treated before conducting the reforming test. The differences in the pellet fabrication protocols are due to the differences existing in the powder's properties. The density of the oxide is lower than the density of iron and the pellets need to be neither too thin nor too thick to have a minimum mechanical resistance. Also, the larger size of original particles need longer pressing times in order to form strong “stand alone” pellets.

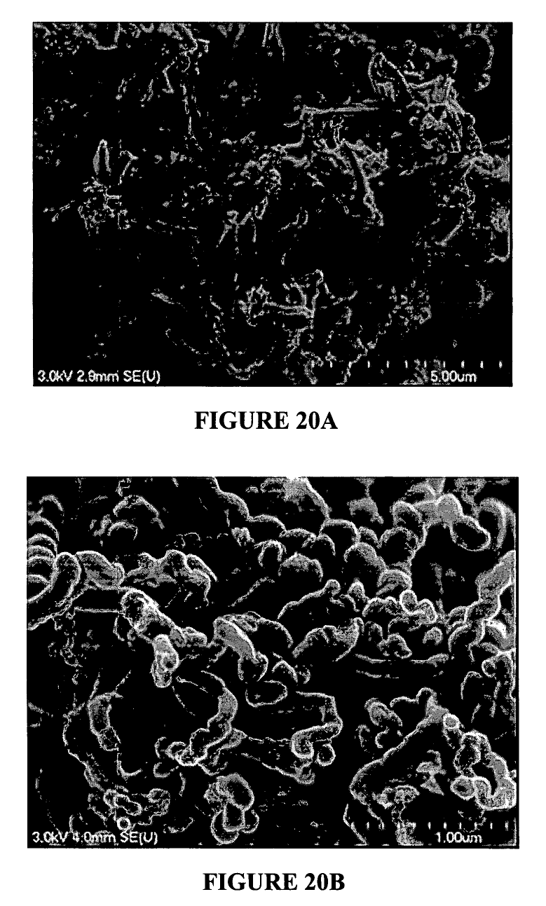

Dry reforming tests, performed under the same flow and temperature conditions as used previously, gave high ethanol conversion yields (in both cases, the mass spectrograph detector did not find ethanol at the exhaust of the setting). The reason for this is that the space velocity is lower than with the catalysts 1-4, due to the higher specific surface of the powders. The effective difference with catalysts 1-4 cannot be calculated precisely because of powder packing, which reduces the circulation of gases within the catalyst particles. High levels of carbon were obtained for both catalysts 5 and 6, but the appearance and nature of the carbon is significantly different. In the case of catalyst 5 (iron powder), disorganized graphitic carbon, of low technical value, was obtained (see FIG. 20A). The magnetite powder provided filamentous carbon of filament diameter compatible with the starting size of the particles (see FIG. 20B).

### 8.7. Conclusion

This study has demonstrated that a sheet of common carbon steel is able, following an activation pretreatment, to produce carbon nanofilaments. If heat treatment is important for the steel substrate phase changes and the favorable surface conditions for the oxides/carbon particles formation, the slow-oxidative step seems to be key to the process of preparing the surface. The oxidized iron particles are able to resist the heat of the reforming phase until they are used by the reactive gas to decompose the ethanol and CO₂ into H₂ and CO and produce carbon filaments and MWNT. The present invention therefore provides the steps necessary to produce valuable carbon nanofilaments and synthesis gas in an one step process, using low cost and easy to handle catalysts (based on carbon steel) while easily recuperating the carbon product by mechanical means.

The process described above allows to simultaneously sequestering carbon and reform a gaseous organic material to produce a synthesis gas. The proposed 2D catalysts maximize the carbon sequestration. Therefore, an important amount of carbon is withdrawn from the biosphere cycle to reduce greenhouse effect gases.

The embodiments of the invention described above are intended to be exemplary only. The scope of the invention is therefore intended to be limited solely by the scope of the appended claims.

1. A carbon sequestration and dry reforming process comprising the steps of:
providing a reactant gas mixture comprising carbon dioxide and an organic material;
providing at least one catalyst for dry reforming the reactant gas mixture and sequestering carbon, at least one of the at least one catalyst being a two-dimension carbon sequestration catalyst;
contacting the reactant gas mixture with the at least one catalyst under conditions wherein the reactant gas mixture is at least partly reformed into a product gas mixture including a synthesis gas and solid carbon particles are formed over the at least one two-dimension carbon sequestration catalyst; and recovering the product gas mixture and the solid carbon particles.

2. A carbon sequestration and dry reforming process as claimed in claim 1, further comprising mechanically withdrawing the solid carbon particles.

3. A carbon sequestration and dry reforming process as claimed in claim 1, further comprising adding steam to the reactant gas mixture.

4. A carbon sequestration and dry reforming process as claimed in claim 1, further comprising activating the catalyst by producing a superficial iron oxide grains layer by different means as the thermal oxidative treatment under oxidative gas flow or under inert gas followed by oxidative gas.

5. A carbon sequestration and dry reforming process as claimed in claim 1, wherein the organic material and the carbon dioxide in the reactant gas mixture are in a molar ratio ranging between 0.3 and 3.

6. A carbon sequestration and dry reforming process as claimed in claim 1, wherein the dry reforming of the reactant gas mixture is carried out on a three dimension catalyst at a first reaction temperature and then the sequestering of the carbon is carried out on the at least one two dimension catalyst at a second reaction temperature.

7. A carbon sequestration and dry reforming process as claimed in claim 1, wherein at least one of the at least one catalyst comprises an active metal deposited on one of a non-porous support.

8. A carbon sequestration and dry reforming process as claimed in claim 1, wherein the product gas mixture is a fuel for a fuel cell.

9. A carbon sequestration and dry reforming process as claimed in claim 1, wherein the reactant gas mixture is an output product of a fuel cell.

10. A filamentous carbon material resulting from the carbon sequestration and dry reforming process as claimed in claim 1.

11. A synthesis gas resulting from the carbon sequestration and dry reforming process as claimed in claim 1.

12. A carbon sequestration method in a dry reforming process, comprising bringing at least one of a reactant gas mixture including carbon dioxide and an organic material and a dry reformed gas in contact with a two-dimension carbon sequestration catalyst at a temperature wherein a solid carbon deposit is formed at the surface of the two-dimension carbon sequestration catalyst.

13. A carbon sequestration method as claimed in claim 12, wherein the two-dimension carbon sequestration catalyst comprises an activated iron-based catalytic material.

14. The carbon sequestration method as claimed in claim 13, wherein said iron-based catalyst is obtained by thermal-oxidative pretreatment of low-carbon steel material.

15. The carbon sequestration method as claimed in claim 14, wherein said thermal-oxidative pretreatment comprises the following steps:
a) heating said carbon steel material at a temperature above 400° C.; and
b) oxidizing said material at room temperature.

16. The carbon sequestration method as claimed in claim 13, wherein said activated iron-based catalytic material is selected from: iron oxide or iron carbide.

17. The carbon sequestration method as claimed in claim 16, wherein said activated iron-based catalytic material is selected from the group consisting of: Fe₃C, Fe₇C, FeO, Fe₂O₃ and Fe₃O₄.

18. A carbon sequestration method as claimed in claim 13, wherein the iron-based catalytic material comprises at least one of nickel, chrome and cobalt alloying elements.

19. A carbon sequestration method as claimed in claim 13, wherein the iron-based catalytic material is a high temperature resistant iron alloy.

20. A carbon sequestration method as claimed in claim 12, wherein the two-dimension carbon sequestration catalyst comprises an active metal deposited on a non-porous support, the active metal being selected from the group consisting of nickel, platinum group metals promoted nickel, alkali-enhanced nickel, copper-promoted nickel, and tin-promoted nickel.

21. A carbon sequestration and dry reforming reactor comprising:
a) at least one housing, each having at least one gas input and at least one gas output, the at least one gas input being adapted to receive a reactant gas mixture composed of an organic material and carbon dioxide;
b) at least one catalyst disposed in at least one of the at least one housing for dry reforming the reactant gas mixture circulating therein into a product gas mixture and sequestering carbon, at least one of the at least one catalyst being a two-dimension carbon sequestration catalyst; and
c) a heater operatively connected to the reactor for heating at least one of the gas mixture and the at least one catalyst.

22. A carbon sequestration and dry reforming reactor as claimed in claim 21, comprising at least two housings, a first of the at least two housings comprising a three dimension dry reforming catalyst for dry reforming the reactant gas mixture and a second of the at least two housings comprising the at least one two dimension carbon sequestration catalyst.

23. A carbon sequestration and dry reforming reactor as claimed in claim 21, wherein one of the at least one housing comprises a three dimension dry reforming catalyst for dry reforming the reactant gas mixture and the at least one two dimension carbon sequestration catalyst.

24. A carbon sequestration and dry reforming reactor as claimed in claim 21, wherein the reactor is operable in at least one of solid carbon recovery mode and catalyst regeneration mode.

25. A reforming catalyst, comprising an active metal deposited on one of a non-porous support selected from the group consisting of a non-porous metallic support and a non-porous ceramic support, the active metal being selected from the group consisting of nickel, platinum group metals promoted nickel, alkali-enhanced nickel, copper-promoted nickel, and tin-promoted nickel.

26. A reforming catalyst as claimed in claim 25, wherein the non-porous support is a ceramic support selected from the group consisting of alumina, zirconia, and phosphate oxide.

27. A reforming catalyst as claimed in claim 25, wherein the non porous support is a metallic support comprising fritted molybdenum.

28. A reforming catalyst as claimed in claim 25, wherein the reforming catalyst is a dry reforming catalyst.

29. A reforming catalyst as claimed in claim 25, wherein the reforming catalyst is a two dimension catalyst.

30. A reforming catalyst as claimed in claim 25, wherein the catalyst is obtained by impregnation of the non-porous support using one of nitrate salts and chloride salts of the active metal.

31. A reforming catalyst as claimed in claim 25, wherein the catalyst is obtained by thermal plasma deposition on the non-porous support using one of nitrates, carbonates, and chlorides of the active metal.

32. A two-dimension reforming catalyst manufacturing process, comprising:
a) providing a non-porous support;
b) providing a catalytic metal precursor selected from the group consisting of nickel, platinum group metals promoted nickel, alkali-enhanced nickel, copper-promoted nickel, and tin-promoted nickel; and
c) deposing the catalytic metal precursor over the non-porous support.

33. A process as claimed in claim 32, wherein the non-porous support is selected from the group consisting of a non-porous metallic support and a non-porous ceramic support.

34. A process as claimed in claim 32, comprising depositing the catalytic metal precursor by thermal plasma deposition using one of nitrates, carbonates, and chlorides of the catalytic metal precursor.

35. A process as claimed in claim 32, comprising depositing the catalytic metal precursor by impregnation of the non-porous support using one of nitrate salts and chloride salts of the metal.

36. A process as claimed in claim 35, comprising calcinating the assembly of the metal impregnated on the non-porous support.

37. A two-dimension catalyst manufacturing process, comprising:
a) providing a non-porous support;
b) providing a catalytic metal precursor selected from the group consisting of nickel, platinum group metals promoted nickel, alkali-enhanced nickel, copper-promoted nickel, and tin-promoted nickel; and
c) deposing a catalytic material over the support by thermal plasma deposition of the catalytic metal precursor.

38. A process as claimed in claim 37, wherein the catalytic metal precursor is one of a nitrate, a carbonate, and a chloride.

39. A process as claimed in claim 37, wherein the non-porous support is selected from the group consisting of a non-porous metallic support and a non-porous ceramic support.

40. A process as claimed in claim 37, comprising pressing the deposited catalytic material over the substrate.

41. A process as claimed in claim 37, comprising heating the deposited catalytic material under an inert gas flow.

42. A process as claimed in claim 37, wherein the two-dimension catalyst is a reforming catalyst.

43. A two-dimension carbon sequestration catalyst, comprising: an iron-based superficial catalytic material activated by heating under an inert gas atmosphere to a temperature ranging between 700 and 900° C.

44. A two-dimension carbon sequestration catalyst, as claimed in claim 43, wherein the inert gas is nitrogen.

45. A two-dimension carbon sequestration catalyst as claimed in claim 43, wherein the two-dimension catalyst is heated to a temperature higher than the eutectic point and the steel is transformed into its α-phase.

46. A two-dimension carbon sequestration catalyst as claimed in claim 43, wherein the iron-based catalytic material comprises at least one of nickel, chrome and cobalt alloying elements.

47. A two-dimension carbon sequestration catalyst as claimed in claim 43, wherein the iron-based catalytic material is a high temperature resistant iron alloy.

48. A two-dimension carbon sequestration catalyst, comprising: an iron-based non-porous catalytic material activated by thermal-oxidation of low-carbon steel material.

49. The two-dimension carbon sequestration catalyst as claimed in claim 48, wherein said thermal-oxidative pretreatment comprises the following steps:
a) heating said carbon steel material at a temperature above 400° C.; and
b) oxidizing said material to form an iron oxide layer at the surface of the iron.

50. The two-dimension carbon sequestration catalyst as claimed in claim 48, wherein said activated iron-based catalytic material is selected from: iron oxides or iron carbides.

51. The two-dimension carbon sequestration catalyst as claimed in claim 49, wherein said activated iron-based catalytic material is selected from the group consisting of: Fe₃C, Fe₇C, FeO, Fe₂O₃ and Fe₃O₄.
